(19) United States
(12) Patent Application Publication
(10) Pub. No.: US 2025/0272353 A1
(43) Pub. Date: Aug. 28, 2025

(54) METHODS AND APPARATUS FOR COMPUTING POOLING OPERATIONS ON A GRAPHICS PROCESSING UNIT (GPU) ARCHITECTURE

(71) Applicant: INTEL CORPORATION, Santa Clara, CA (US)

(72) Inventors: Aditya Chatterjee, Kolkata (IN); Kareem Mohiddeen Shaik, Bangalore (IN)

(73) Assignee: INTEL CORPORATION, Santa Clara, CA (US)

(21) Appl. No.: 19/070,208

(22) Filed: Mar. 4, 2025

Related U.S. Application Data
(60) Provisional application No. 63/727,543, filed on Dec. 3, 2024.

(51) Int. Cl. G06F 17/16; G06F 12/084

(52) U.S. Cl. CPC G06F 17/16; G06F 12/084; G06F 2212/604

(57) ABSTRACT

An example apparatus includes interface circuitry, machine-readable instructions, and at least one processor circuit to be programmed by the machine-readable instructions to distribute a computing task across one or more cores based on a batch dimension, execute a row pooling operation to generate a first intermediate data output based on the batch dimension and a first pooling size, execute a column pooling operation to produce a second intermediate data output based on the batch dimension and a second pooling size, and generate a final output based on the first intermediate data output and the second intermediate data output.

### RELATED APPLICATION

This patent claims the benefit of U.S. Provisional Patent Application No. 63/727,543, filed Dec. 3, 2024, entitled “Methods and Apparatus for Computing a Pooling Operation on GPU Architecture.” The entire disclosure of U.S. Provisional Patent Application No. 63/727,543 is hereby incorporated by reference in its entirety.

### BACKGROUND

Pooling is applied in deep learning to reduce feature dimensions and complexity of computation as part of image processing. This technique is commonly used in convolutional neural networks (CNNs) to reduce the resolution of a feature map while retaining features needed for classification-based tasks. As such, pooling allows for the retention of essential features while reducing computational complexity and risks associated with overfitting.

### BRIEF DESCRIPTION OF THE DRAWINGS

FIG. 1 is a block diagram of an example implementation of pooling performer circuitry constructed in accordance with teachings of this disclosure to compute pooling operations on a graphics processing unit (GPU) architecture.

FIG. 2 is a flowchart representative of example machine-readable instructions and/or example operations that may be executed, instantiated, and/or performed by example programmable circuitry to implement the example pooling performer circuitry of FIG. 1.

FIG. 3 is a flowchart representative of example machine-readable instructions and/or example operations that may be executed, instantiated, and/or performed by example programmable circuitry to implement the example pooling performer circuitry of FIG. 1 to perform m-dimensional average pooling.

FIG. 4 illustrates an example two-dimensional matrix representing an input image of a given size (N×M) and a resulting output of the pooling operation.

FIG. 5A illustrates an example calculation associated with select row(s) of data as part of a pooling operation performed using the pooling performer circuitry of FIG. 1.

FIG. 5B illustrates an example calculation associated with select column(s) of data as part of a pooling operation performed using the pooling performer circuitry of FIG. 1.

FIG. 6A illustrates an example reordering of dimensions based on a calculation associated with select row(s) of data as part of a pooling operation performed using the pooling performer circuitry of FIG. 1.

FIG. 6B illustrates an example pooling operation performed using the pooling performer circuitry of FIG. 1.

FIG. 7A illustrates example memory accesses using known pooling techniques.

FIG. 7B illustrates example reduced memory accesses when performing pooling operations using the pooling performer circuitry of FIG. 1.

FIG. 8 shows example pooling operation results with and without the use of Single Instruction, Multiple Data (SIMD)-based optimization.

FIG. 9 is a block diagram of an example processing platform including programmable circuitry structured to execute, instantiate, and/or perform the example machine readable instructions and/or perform the example operations of FIGS. 2-3 to implement the pooling performer circuitry of FIG. 1.

FIG. 10 is a block diagram of an example implementation of the programmable circuitry of FIG. 9.

FIG. 11 is a block diagram of another example implementation of the programmable circuitry of FIG. 9.

FIG. 12 is a block diagram of an example software/firmware/instructions distribution platform (e.g., one or more servers) to distribute software, instructions, and/or firmware (e.g., corresponding to the example machine readable instructions of FIGS. 2-3) to client devices associated with end users and/or consumers (e.g., for license, sale, and/or use), retailers (e.g., for sale, re-sale, license, and/or sub-license), and/or original equipment manufacturers (OEMs) (e.g., for inclusion in products to be distributed to, for example, retailers and/or to other end users such as direct buy customers).

In general, the same reference numbers will be used throughout the drawing(s) and accompanying written description to refer to the same or like parts. The figures are not necessarily to scale.

### DETAILED DESCRIPTION

Pooling is a common operation in deep learning models that represents the second most computationally intensive operation associated with Convolutional Neural Networks (CNNs), consuming over twenty percent of inference time. However, the application of pooling operations in connection with Graphics Processing Units (GPUs) does not provide any fundamental improvement in performance. Current techniques associated with GPUs include a brute force approach to pooling operations in major known frameworks (e.g., such as PyTorch, TensorFlow, Compute Unified Device Architecture (CUDA), etc.). For instance, assuming an input size of O(N²) and a kernel size of O(K²), known pooling techniques define time complexity as O(N² K²). While an average pooling operation that calculates the average value for patches of a feature map (e.g., AvgPool) uses a time complexity of O(N²), this approach is not desirable for a GPU architecture, resulting in concurrent process reductions. As such, a brute force approach executes faster when performing computations on a GPU, as compared to using a time complexity of O(N²). Similarly, for pooling operations that calculate a maximum value for patches of a feature map (e.g., MaxPool), there is a lack of computation techniques that can be implemented on GPUs. Therefore, pooling operations associated with a GPU-based architecture are limited to the use of brute force pooling.

Methods and apparatus disclosed herein address the lack of existing effective pooling operation-based computations on GPUs by (1) reducing the time complexity of two-dimensional pooling by a factor of kernel size K, (2) reducing memory accesses in the GPU, and (3) reducing the number of operations and/or Single Instruction Multiple Data (SIMD) instructions by a factor of K/2 for two-dimensional pooling. Examples disclosed herein determine pooling on one dimension at a time and process dimensions in a set order (e.g., right to left). For a particular element in a specific dimension, one-dimensional pooling can be determined using subsequent K elements, updating input(s) for subsequent dimension(s). In some examples, intermediate output is stored by interchanging dimensions to ensure contiguous memory access for subsequent dimension(s). As such, methods and apparatus disclosed herein introduce an efficient method of computing a pooling operation using GPU-based architecture(s). Methods and apparatus disclosed herein result in a performance improvement of up to 13.7% for end-to-end inference and training associated with CNN-based models. Furthermore, examples disclosed herein increase GPU-based performance of two-dimensional pooling operations by a factor of K/2 and reduce involved computations and/or memory accesses by a factor of K/2. As such, the examples disclosed herein improve the operation of a computer and/or computing system.

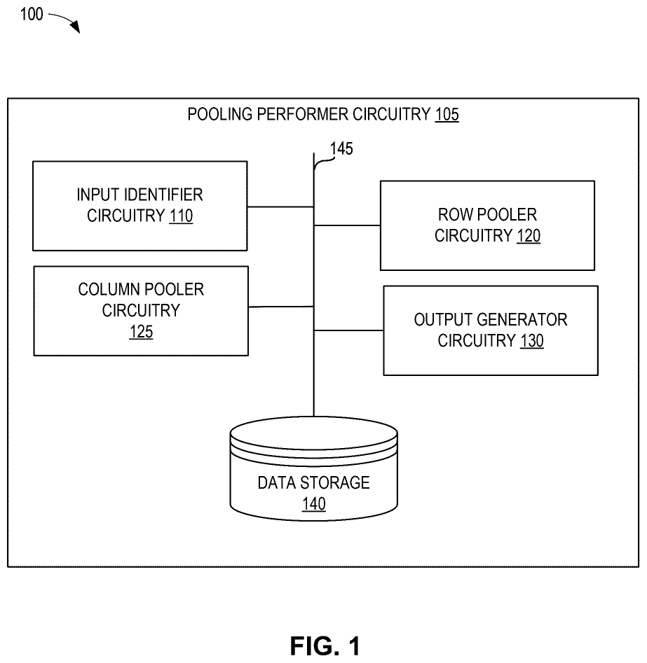

FIG. 1 is a block diagram 100 illustrating an example implementation of the pooling performer circuitry 105 constructed in accordance with teachings of this disclosure to perform pooling operation-based computations on GPUs. The pooling performer circuitry 105 of FIG. 1 may be instantiated (e.g., creating an instance of, bring into being for any length of time, materialize, implement, etc.) by programmable circuitry. For example, programmable circuitry may be implemented by a Central Processing Unit (CPU) executing first instructions, a field programmable gate array, a programmable logic device (PLD), a generic array logic (GAL) device, a programmable array logic (PAL) device, a complex programmable logic device (CPLD), a simple programmable logic device (SPLD), a microcontroller (MCU), a programmable system on chip (PSoC), etc. Additionally or alternatively, the pooling performer circuitry 105 of FIG. 1 may be instantiated (e.g., creating an instance of, bring into being for any length of time, materialize, implement, etc.) by (i) an Application Specific Integrated Circuit (ASIC) and/or (ii) a Field Programmable Gate Array (FPGA) (e.g., another form of programmable circuitry) structured and/or configured in response to execution of second instructions to perform operations corresponding to the first instructions. It should be understood that some or all of the circuitry of FIG. 1 may, thus, be instantiated at the same or different times. Some or all of the circuitry of FIG. 1 may be instantiated, for example, in one or more threads executing concurrently on hardware and/or in series on hardware. Moreover, in some examples, some or all of the circuitry of FIG. 1 may be implemented by microprocessor circuitry executing instructions and/or FPGA circuitry performing operations to implement one or more virtual machines and/or containers.

In the example of FIG. 1, the pooling performer circuitry 105 includes example input identifier circuitry 110, example row pooler circuitry 120, example column pooler circuitry 125, example output generator circuitry 130, and example data storage 140. In the example of FIG. 1, the input identifier circuitry 110, the row pooler circuitry 120, the column pooler circuitry 125, the output generator circuitry 130, and the data storage 140 are in communication with an example bus 145.

The input identifier circuitry 110 receives N-dimensional input that includes (1) an input batch (B) of N-M dimensions (e.g., {B₁, B₂, . . . , B_{N-M}}), including input working data (I) of M dimensions (e.g., {I₁, I₂, . . . , I_{M}}) and (2) input pooling kernel size (K) of M dimensions (e.g., {K₁, K₂, . . . , K_{M}}). Input data received by the input identifier circuitry 110 can be used by the pooling performer circuitry 105 to traverse the received batch (B) of N-M dimensions and process the input working data (I) of M dimensions. As described in more detail in examples disclosed herein, the pooling performer circuitry 105 processes each dimension of the input working data (I) from the rightmost dimension (e.g., I_{M}) to the leftmost dimension (e.g., I₁) and sums subsequent elements of the input pooling size (e.g., Kᵢ elements) for all elements in a current dimension (Dᵢ). For example, for all possible values of dᵢ, d₂, . . . , d_{M}, where dⱼ corresponds to the j^{th} dimensional value of working data (e.g., such that 0≤dⱼ<Iᵢ), the summation can be represented in accordance with Equation 1:

$$input [ {d}_{1} ] [ {d}_{2} ] … [ {d}_{l} ] … [ {d}_{M} ] = {\sum }_{m = 0}^{{m < Ki}_{di + m < Bi}} input [ {d}_{1} ] [ {d}_{2} ] … [ {d}_{i} + m ] … [ {d}_{M} ] \qquad Equation 1$$

Once the summation of subsequent elements is complete, the pooling performer circuitry 105 performs average pooling by dividing each element by the kernel size (K), in accordance with Equation 2, where the modified input represents the final output of the pooling operation:

$$input [ {d}_{1} ] [ {d}_{2} ] … [ {d}_{M} ] = \frac{input [ {d}_{1} ] [ {d}_{2} ] … [ {d}_{M} ]}{( {K}_{1} * {K}_{1} * … * {K}_{M} )} \qquad Equation 2$$

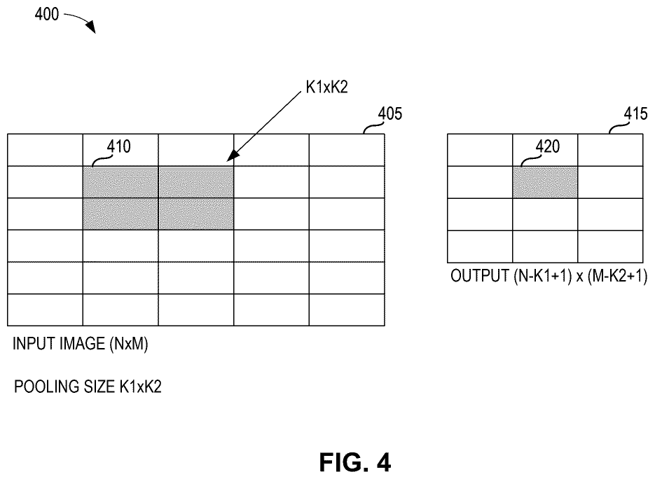

For example, in the case of two-dimensional pooling, the input identifier circuitry 110 receives input in the NCHW data format, where N and C are batch dimensions (e.g., N=number of images, C=number of channels), and H=height while W=width. In examples disclosed herein, the input identifier circuitry 110 identifies the pooling kernel-based size as K1×K2, the output size is represented by the batch dimensions (N, C), as well as the results of the following equations: H−K1+1 and W−K2+1 (e.g., as illustrated in connection with FIG. 4). As described in more detail below, the pooling performer circuitry 105 further performs the following steps using the received input data: (1) Distribution of workload(s) (e.g., computing tasks) across different cores based on the batch dimensions, (2) processing of a first dimension (e.g., row-based processing performed using the row pooler circuitry 120), and (3) processing of a second dimension (e.g., column-based processing performed using the column pooler circuitry 125). For example, the input identifier circuitry 110 distributes the workload and/or computing task across different cores (e.g., using an Intel® Xe GPU architecture) based on the batch dimensions (NC). In examples disclosed herein, the pooling dimensions are represented by HW, with each core receiving a set of data units (H×W) for processing (e.g., as represented by mHW where m is a component from batch dimensions NC).

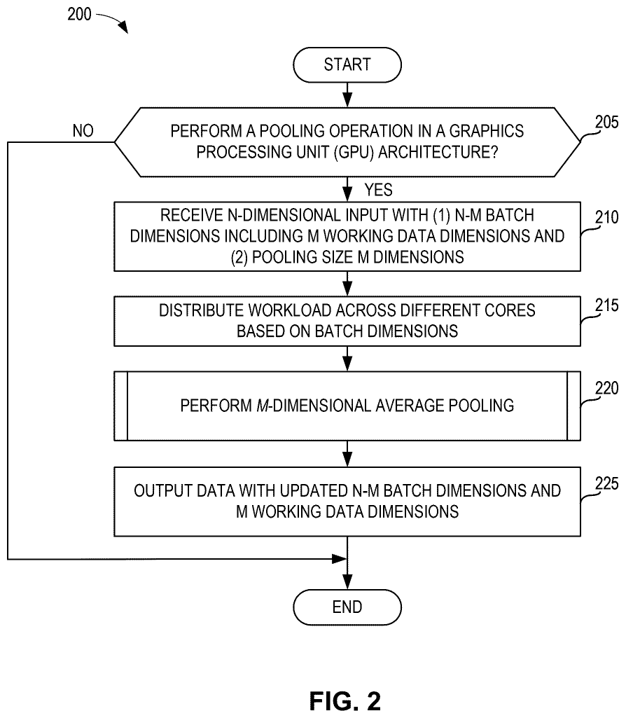

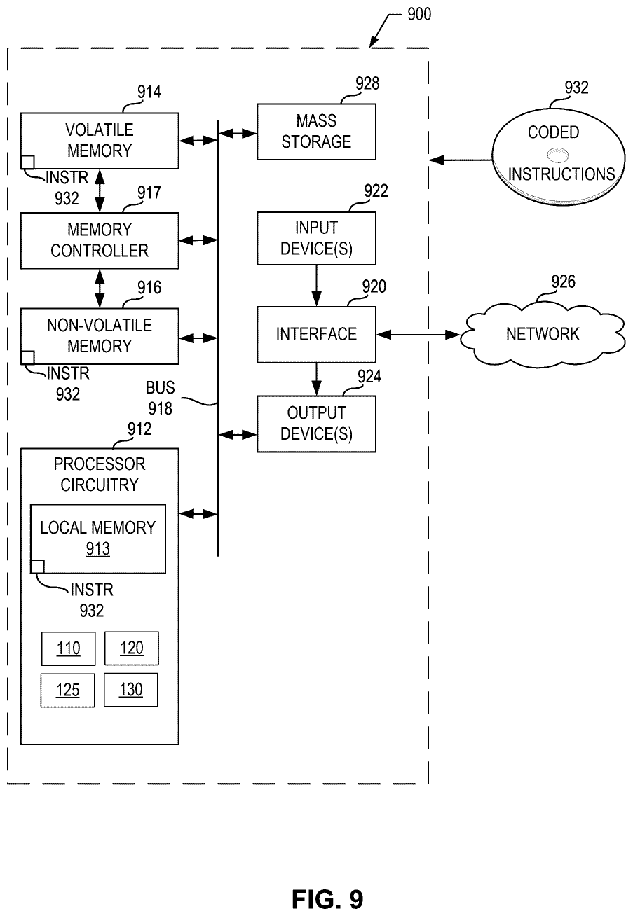

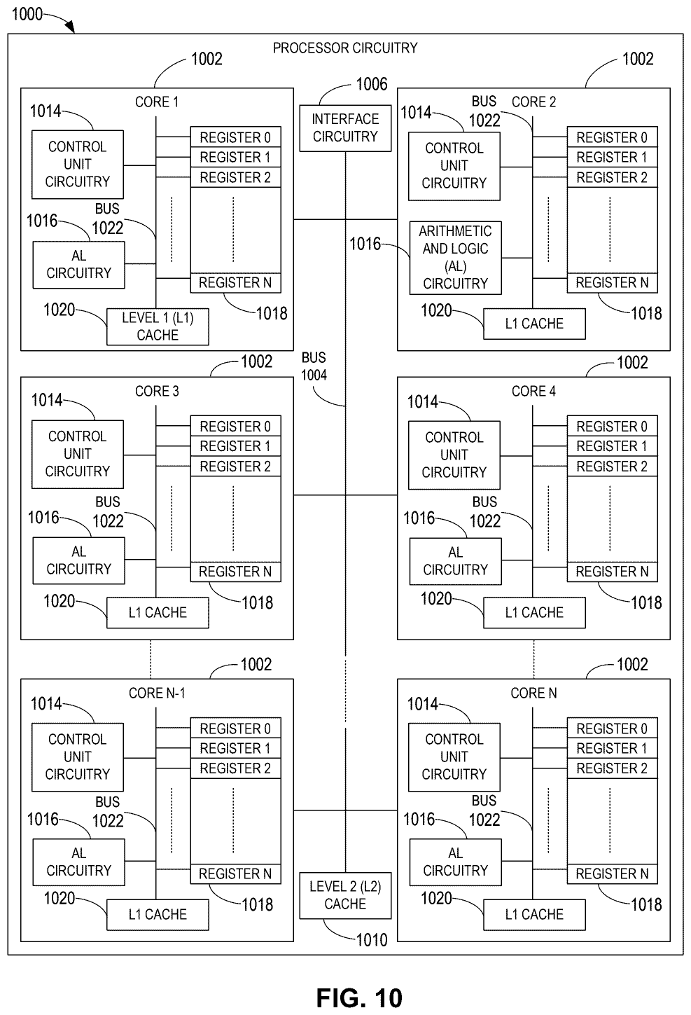

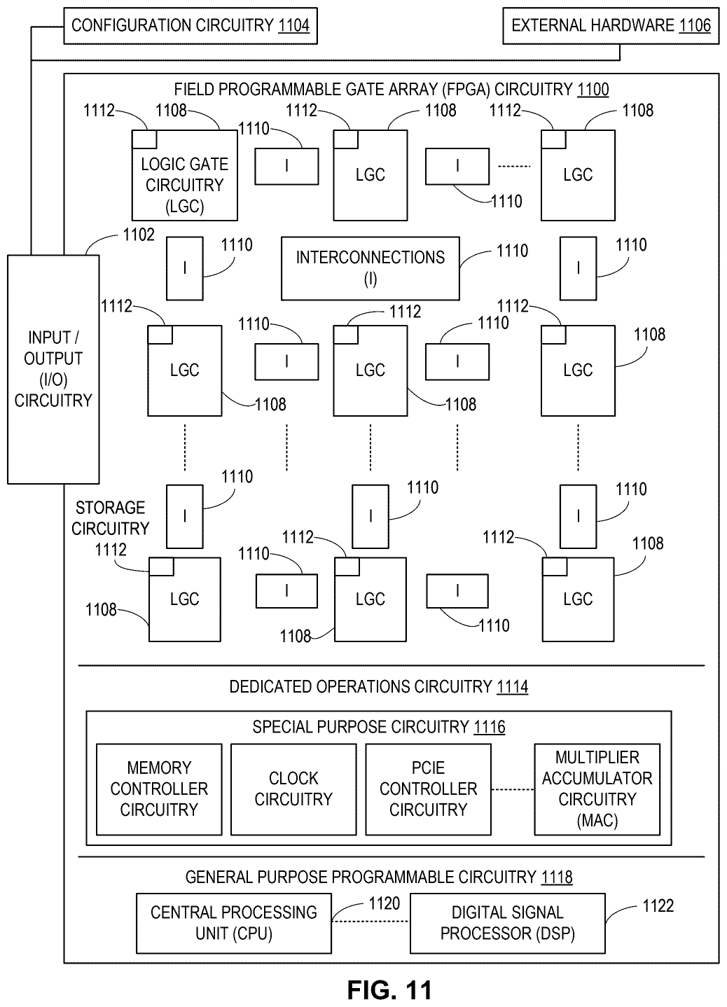

In some examples, the apparatus includes means for distributing a computing task. For example, the means for distributing a computing task may be implemented by input identifier circuitry 110. In some examples, the input identifier circuitry 110 may be instantiated by programmable circuitry such as the example programmable circuitry 912 of FIG. 9. For instance, the input identifier circuitry 110 may be instantiated by the example microprocessor 1000 of FIG. 10 executing machine executable instructions such as those implemented by at least block 210 of FIG. 2. In some examples, the input identifier circuitry 110 may be instantiated by hardware logic circuitry, which may be implemented by an ASIC, XPU, or the FPGA circuitry 1100 of FIG. 11 structured to perform operations corresponding to the machine readable instructions. Additionally or alternatively, the input identifier circuitry 110 may be instantiated by any other combination of hardware, software, and/or firmware. For example, the input identifier circuitry 110 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) structured to execute some or all of the machine readable instructions and/or to perform some or all of the operations corresponding to the machine readable instructions without executing software or firmware, but other structures are likewise appropriate.

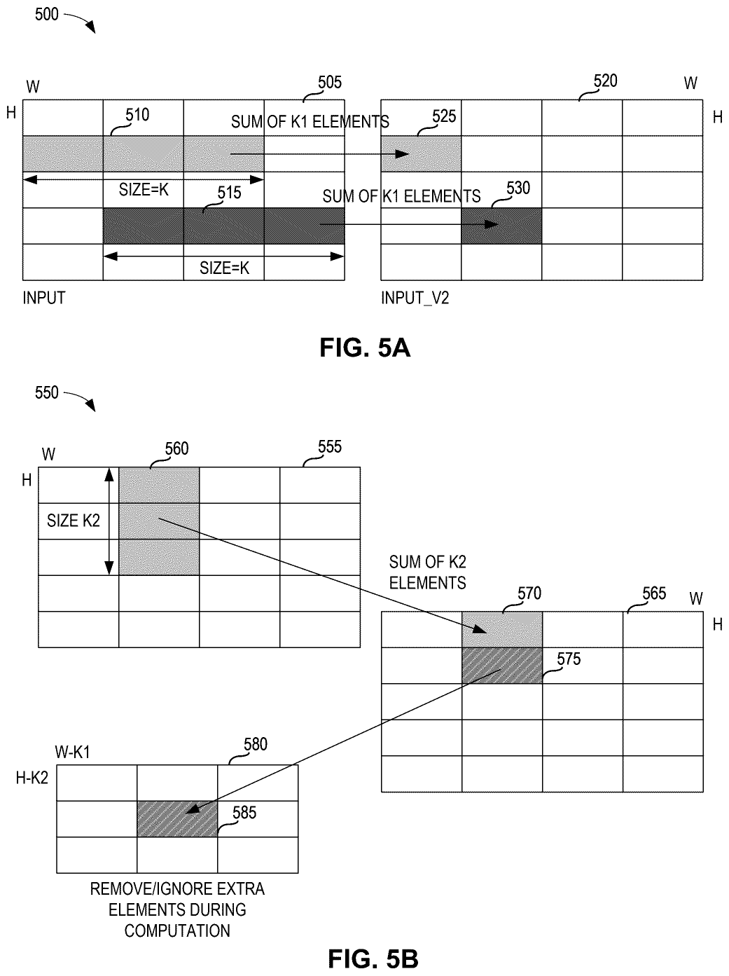

The row pooler circuitry 120 performs processing of the first dimension (e.g., row-based pooling operations) based on input received from the input identifier circuitry 110. In examples disclosed herein, the row pooler circuitry 120 receives input represented as input[H][W], creating intermediate data input_v2[H][W]. For example, considering a single data unit (H×W) and a single core, methods and apparatus disclosed herein accommodate as many rows (e.g., of size W) as possible in a shared local memory (SLM). Furthermore, the row pooler circuitry 120 can perform one set of memory transfers to an L1 cache and/or the SLM, such that a thread (e.g., a virtual sequence of instructions that a core executes) can be used to compute an element of intermediate output(s). For example, if a thread is for output at an index[i][j], the row pooler circuitry 120 uses the thread to obtain the subsequent K elements from input[i][j] using the SLM and computes the sum as the resulting intermediate output, as described in more detail in connection with FIG. 5A. Subsequently, the row pooler circuitry 120 moves the intermediate output to the SLM. For example, the row pooler circuitry 120 generates the following intermediate outputs (e.g., Equations 3-5), such that if there are less than K elements left, only the remaining elements in the row are considered, as shown below and in connection with FIG. 5A:

$$input\_v 2 [ i ] [ j ] = {\sum }_{m = j}^{{( m < W )}^{m = j + K 1 - 1}} input [ i ] m \qquad Equation 3$$

$$Equation 4$$

$$input\_v 2 [ i ] [ j ] ] = Sum of ( input [ i ] [ j ] , input [ i ] [ j + 1 ] , input [ i ] [ j + 2 ] , … , input [ i ] [ j + K 1 - 1 ] )$$

$$Equation 5$$

$$input\_v 2 [ i ] [ j ] ] = Sum of next K element in the same row starting from input [ i ] [ j ]$$

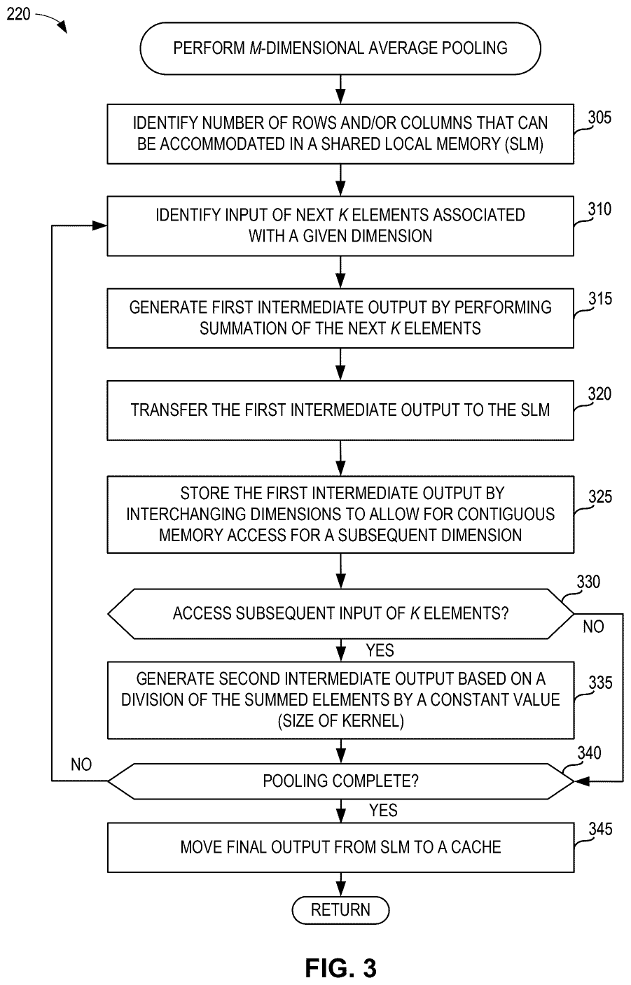

In some examples, the apparatus includes means for executing a row pooling operation. For example, the means for executing a row pooling operation may be implemented by row pooler circuitry 120. In some examples, the row pooler circuitry 120 may be instantiated by programmable circuitry such as the example programmable circuitry 912 of FIG. 9. For instance, the row pooler circuitry 120 may be instantiated by the example microprocessor 1000 of FIG. 10 executing machine executable instructions such as those implemented by at least block 315 of FIG. 3. In some examples, the row pooler circuitry 120 may be instantiated by hardware logic circuitry, which may be implemented by an ASIC, XPU, or the FPGA circuitry 1100 of FIG. 11 structured to perform operations corresponding to the machine readable instructions. Additionally or alternatively, the row pooler circuitry 120 may be instantiated by any other combination of hardware, software, and/or firmware. For example, the row pooler circuitry 120 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) structured to execute some or all of the machine readable instructions and/or to perform some or all of the operations corresponding to the machine readable instructions without executing software or firmware, but other structures are likewise appropriate.

The column pooler circuitry 125 performs processing of the second dimension (e.g., column-based pooling operations). For example, the column pooler circuitry 125 obtains the input(s) input_v2[H][W], with output(s) represented as input_v3[H−K1+1][W−K2+1]. In examples disclosed herein, thread(s) associated with the core(s) can be used to determine an element of the subsequent intermediate output. For example, if the thread is for output at index[i][j], the column pooler circuitry 125 obtains the subsequent K elements associated with input[i][j] from the SLM (e.g., using a column major order), and performs a summation operation to determine the corresponding output (e.g., Equation 6-8), dividing the sum by a constant value (K1×K2), as shown below and in connection with FIG. 5B:

$$input\_v 3 [ i ] [ j ] = ( {\sum }_{m = i}^{{( m < W )}^{m = i + K 2 - 1}} input\_v 2 [ m ] [ i ] ) / ( K 1 \times K 2 ) \qquad Equation 6$$

$$Equation 7$$

$$input\_v 3 [ i ] [ j ] = Sum of ( input\_v 2 [ i ] , input\_v 2 [ i + 1 ] [ j ] , input\_v 2 [ i + 2 ] [ j ] , … , input\_v 2 [ i + K 2 - 1 ] [ j ] ) / ( K 1 \times K 2 )$$

$$Equation 8$$

$$input\_v 3 [ i ] [ j ] = Sum of next K element in the same column starting from input [ i ] [ j ]$$

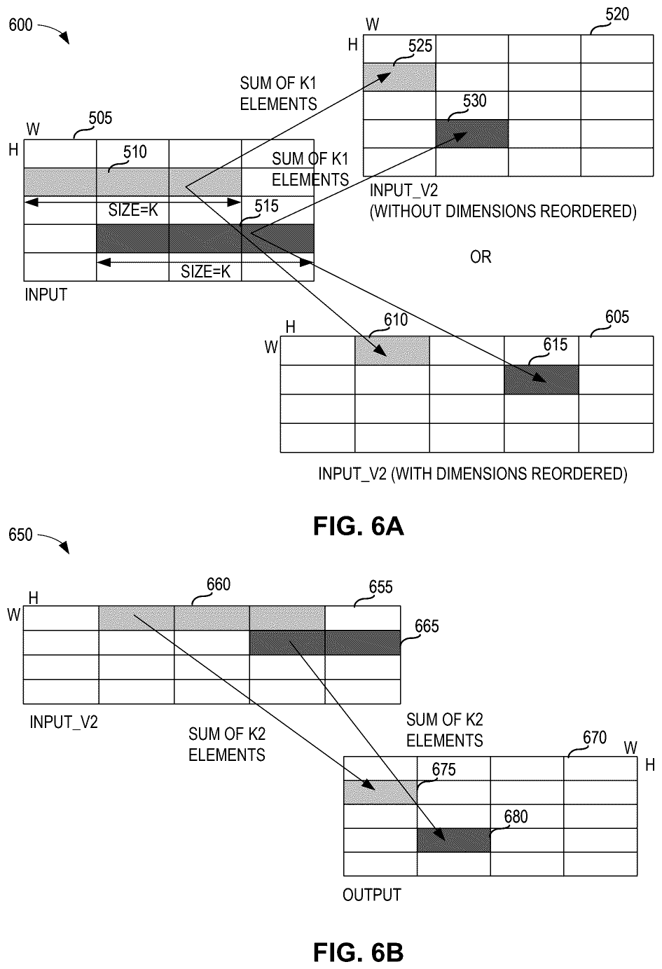

As described in connection with the row pooler circuitry 120, if there are less than K elements remaining, the column pooler circuitry 125 considers only the remaining elements in the column. In examples disclosed herein, intermediate output is stored by interchanging dimensions to keep memory access contiguous. As such, instead of input_v2[H][W], the intermediate output can be stored as input_v2[W][H]. Storing in this format does not introduce any overhead in the GPU, while ensuring contiguous memory access for subsequent dimension(s). For a two-dimensional (2D) matrix, this process is similar to storing in column major instead of row major, as shown in more detail in connection with FIG. 6A. Likewise, processing of all dimensions changes the order except for the last dimension. In examples disclosed herein, the last dimension performs row-wise pooling, as the last dimension from the left is the original last dimension on the right and stores the final output in the correct order. Storing the output in the correct order also does not introduce any overhead in the GPU. In the example of column-based pooling, the current dimension is designated as the last dimension, as shown in connection with FIG. 6B.

Furthermore, in examples disclosed herein, custom stride and padding (e.g., an extension operation) can be used to determine how a convolutional operation is applied to an input, affecting the output size and/or the extraction of features. While padding refers to the process of adding extra pixels around the border of the input image, stride refers to the number of pixels by which the filter (e.g., kernel) moves or slides across an input image. In examples disclosed herein, when the extension operation(s) have a set value (e.g., stride=1 and padding=0), input_v3 represents the pooling output and the row pooler circuitry 120 moves the final output from the SLM to the L2 cache. For example, based on custom stride, the row pooler circuitry 120 includes elements that can be skipped or ignored during row-based pooling operations. In addition to stride and padding, methods and apparatus disclosed herein also encompass other variants of pooling (e.g., such as average pooling (AvgPool), maximum pooling to calculate a maximum value for patches of a feature map (MaxPool), minimum pooling (MinPool), adaptive feature pooling, etc.).

Methods and apparatus disclosed herein can be used for any type of pooling variant(s) that follow the following designation: F(array[0:N])=F(F(array[0:i]), F(array[i+1,N])), where F( ) is the pooling compute function, with a sum identified for an AvgPool operation, a maximum identified for a MaxPool operation, and so on. For example, given Sum([1, 5, 9, 2, 4]), the pooling-based summation calculation can proceed as Sum(Sum[1, 5], Sum[9, 2, 4]) =Sum(6, 15)=2, such that only a core operation in computing each element in the i^{th} dimensional processing may need to be adjusted. In contrast to operations performed using AvgPool, operations performed using MaxPool focus on identifying a maximum of all elements that need to be computed to avoid the division of the pooling size at the end of the operation, as is described in connection with the AvgPool operation.

While examples disclosed herein focus on the use of two-dimensional (2D) pooling, methods and apparatus disclosed herein can also be applied in connection with extensions handling M-dimensional pooling. For example, 2D pooling includes the processing of row(s) followed by the processing of column(s) with the output of the previous row processing being used as the input of the column processing. Similarly, for M-dimensional pooling, processing can be performed on each dimension in order, such that the input of i^{th} dimensional processing represents the output of (i−1)^{th} dimensional processing.

Considering time and/or space complexities associated with computing operations, known methods for computing 2D pooling operations on a GPU (e.g., in connection with deep learning frameworks) result in a time complexity of O(N² K²) and a space complexity of O((N−K+1)²). Conversely, examples disclosed herein result in a time complexity of O(N² K) (e.g., with an improvement by a factor of K) and a space complexity of O(N²). While an approach exists for computing AvgPool and MaxPool operations in O(N²) time, this approach is not optimal for GPUs (e.g., unlike for central processing units (CPUs) associated with specific dimensions). Moreover, there is a lack of a common approach that can be used for performing all types of pooling variations while achieving the O(N²) time complexity.

As previously described, methods and apparatus disclosed herein allow for computing any type of pooling variation on a GPU, reducing the number of computational step(s) (e.g., by computing common components only once) and maintaining a high number of parallel threads (e.g., keeping the thread(s) independent of each other by splitting the pooling operation(s) into two separate steps). In connection with three-dimensional (3D) pooling, as opposed to 2D pooling described above, the time complexity of known methods is O(N³ K³), while methods and apparatus disclosed herein focus on achieving a time complexity of (N³ K). Furthermore, methods and apparatus disclosed herein improve time complexity by a factor of O(K^{D-1}/D)) for all D-dimensional pooling (e.g., represented by O(K^{D})), the improvement taking into consideration the number of dimensions that need to remain constant for a pooling variant (e.g., AvgPool, MaxPool, etc.).

Additionally, the number of SIMD instructions associated with the case of 2D pooling and/or 3D pooling can be defined using methods and apparatus disclosed herein. For 2D pooling-associated operations using known methods, pooling on a sub-matrix of size K×K of the input data is computed for each output element. To improve SIMD-based instructions associated with 2D pooling, K SIMD instructions are obtained using the row pooler circuitry 120 and/or the column pooler circuitry 125. In examples disclosed herein, contiguous K elements associated with a row are connected to one SIMD instruction (e.g., assuming K less than or equal to the SIMD width). Similarly, methods and apparatus disclosed herein introduce the use of two steps, such that a total of two SIMD instructions are performed for each element. For example, while the number of SIMD instructions used in known methods can be represented as N² * K, the number of SIMD instructions examples disclosed herein can be represented as N² * 2. In examples disclosed herein, the SIMD instructions are reduced by a factor of K/2 (e.g., defining the expected improvement in performance). For D-dimensional pooling, SIMD instructions are reduced by a factor of K^{D-1}/D. As such, for 3D pooling, the improvement is identified as K2/3. As an example, for a kernel size of 11, methods and apparatus disclosed herein introduce an improvement of 40.33 times.

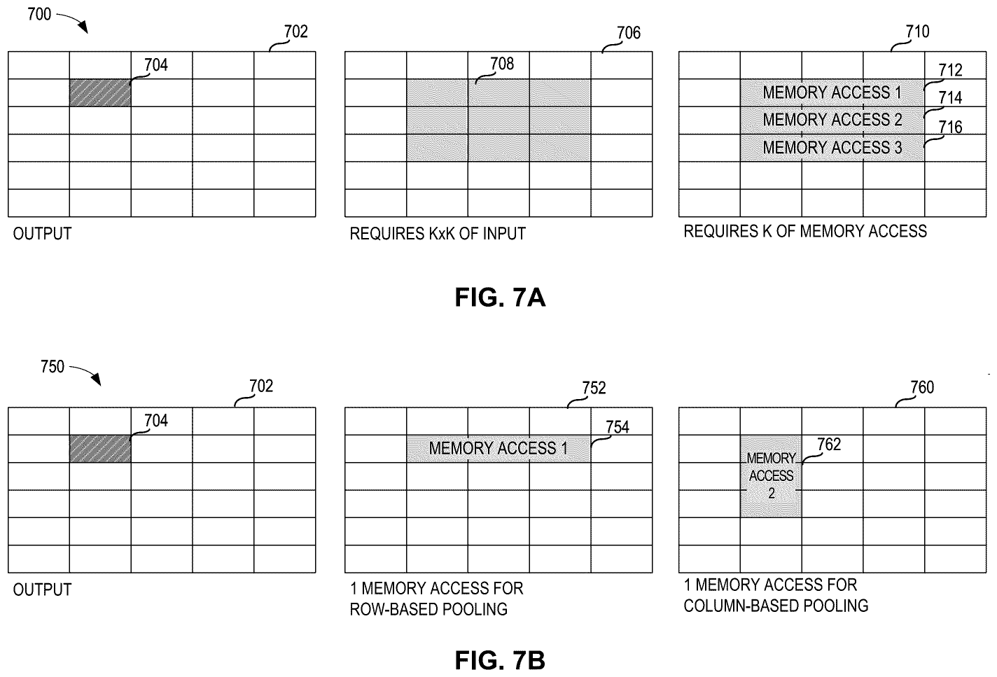

In addition to a reduction in SIMD-based instructions, memory accesses can also be decreased by a factor of K. For example, since pooling is a memory-bound operation, reducing the number of memory accesses for each element improves pooling-related performance significantly. Using known methods, for every output element, K×K input elements are required for 2D pooling. As this memory is contiguous in row-based dimensions only, K memory accesses are used for K sections of contiguous memory, as shown in more detail in connection with FIG. 7A. In examples disclosed herein, the number of memory accesses is constant (e.g., representing the number of pooling dimensions). For 2D pooling, examples disclosed herein rely on two memory accesses for every output element, as shown in more detail in connection with FIG. 7B.

As previously described in connection with row-based pooling operations, the row pooler circuitry 120 stores transposed data, converting the column to row for contiguous memory access. In examples disclosed herein, reduced memory accesses help in improved execution of SIMD 16 instructions. For M-dimensional pooling, the number of memory accesses associated with known methods can be defined as K^{D-1}, while the number of memory accesses associated with methods and apparatus disclosed herein can be defined as D, where D represents the number of pooling dimensions, and K represents the kernel size of pooling. As such, methods and apparatus disclosed herein reduce the number of memory accesses by a factor of K^{D-1}/D. In examples disclosed herein, the time complexity of the pooling method is improved by a factor of K^{D-1} for GPU-based performances, the number of memory accesses in a GPU is reduced, and the number of computations and/or SIMD instructions is also reduced by up to a factor of K^{D-1}/D. Accordingly, methods and apparatus disclosed herein introduce a fundamental improvement over known methods of pooling as supported by deep learning frameworks and/or libraries for a GPU-based architecture.

In some examples, the apparatus includes means for executing a column pooling operation. For example, the means for executing a column pooling operation may be implemented by column pooler circuitry 125. In some examples, the column pooler circuitry 125 may be instantiated by programmable circuitry such as the example programmable circuitry 912 of FIG. 9. For instance, the column pooler circuitry 125 may be instantiated by the example microprocessor 1000 of FIG. 10 executing machine executable instructions such as those implemented by at least block 335 of FIG. 3. In some examples, the column pooler circuitry 125 may be instantiated by hardware logic circuitry, which may be implemented by an ASIC, XPU, or the FPGA circuitry 1100 of FIG. 11 structured to perform operations corresponding to the machine readable instructions. Additionally or alternatively, the column pooler circuitry 125 may be instantiated by any other combination of hardware, software, and/or firmware. For example, the column pooler circuitry 125 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) structured to execute some or all of the machine readable instructions and/or to perform some or all of the operations corresponding to the machine readable instructions without executing software or firmware, but other structures are likewise appropriate.

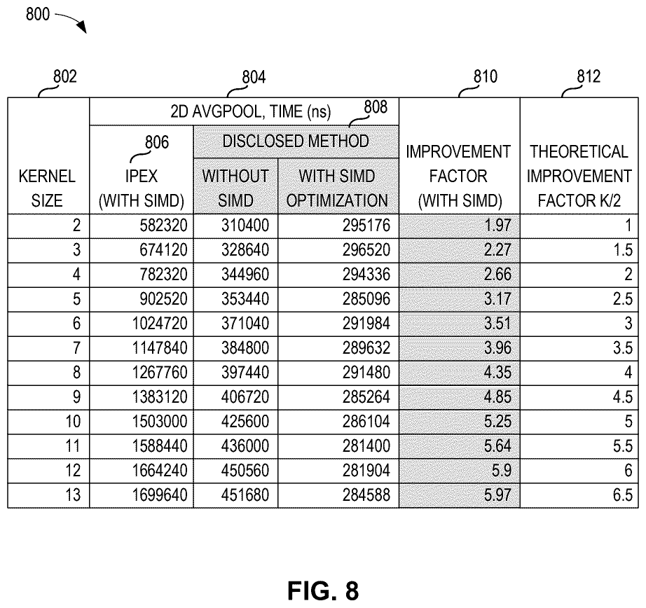

The output generator circuitry 130 generates output data with (1) an output batch (Bₒᵤₜ) of N-M dimensions (e.g., {B_{out_1}, B_{out_2},. . . , B_{out_N-M}}) and (2) an output working data (O) of M dimensions {O₁, O₂, . . . , O_{M}}, such that Oᵢ=Iᵢ−Kᵢ+1 (e.g., where I corresponds to the input working data and K corresponds to the input pooling size). In examples disclosed herein, the output generator circuitry 130 provides output(s) associated with the row-based pooling operations (e.g., performed using the row pooler circuitry 120) and/or the column-based pooling operations (e.g., performed using the column pooler circuitry 125). In some examples, the output generator circuitry 130 outputs a number of memory accesses and/or a number of SIMD instructions associated with 2D and/or 3D pooling operations. In some examples, the output generator circuitry 130 provides output(s) related to improvement factors, as shown in connection with FIG. 8. In some examples, the output generator circuitry 130 applies an extension operation (e.g., using a stride or a padding) as part of the pooling operation. In some examples, the output generator circuitry 130 transfers the first intermediate data output and/or the second intermediate data output from the SLM to a cache.

In some examples, the apparatus includes means for generating a final output. For example, the means for generating a final output may be implemented by output generator circuitry 130. In some examples, the output generator circuitry 130 may be instantiated by programmable circuitry such as the example programmable circuitry 912 of FIG. 9. For instance, the output generator circuitry 130 may be instantiated by the example microprocessor 1000 of FIG. 10 executing machine executable instructions such as those implemented by at least block 225 of FIG. 2. In some examples, the output generator circuitry 130 may be instantiated by hardware logic circuitry, which may be implemented by an ASIC, XPU, or the FPGA circuitry 1100 of FIG. 11 structured to perform operations corresponding to the machine readable instructions. Additionally or alternatively, the output generator circuitry 130 may be instantiated by any other combination of hardware, software, and/or firmware. For example, the output generator circuitry 130 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) structured to execute some or all of the machine readable instructions and/or to perform some or all of the operations corresponding to the machine readable instructions without executing software or firmware, but other structures are likewise appropriate.

The data storage 140 can be used to store any information associated with the input identifier circuitry 110, the row pooler circuitry 120, the column pooler circuitry 125, and/or the output generator circuitry 130. The data storage 140 of the illustrated example of FIG. 1 can be implemented by any memory, storage device and/or storage disc for storing data such as flash memory, magnetic media, optical media, etc. Furthermore, the data stored in the data storage 140 can be in any data format such as binary data, comma delimited data, tab delimited data, structured query language (SQL) structures, image data, etc.

While an example manner of implementing the pooling performer circuitry 105 is illustrated in FIG. 1, one or more of the elements, processes and/or devices illustrated in FIG. 1 may be combined, divided, re-arranged, omitted, eliminated and/or implemented in any other way. Further, the example input identifier circuitry 110, the example row pooler circuitry 120, the example column pooler circuitry 125, the example output generator circuitry 130 and/or, more generally, the pooling performer circuitry 105 of FIG. 1 may be implemented by hardware, software, firmware and/or any combination of hardware, software and/or firmware. Thus, for example, any of the example input identifier circuitry 110, the example row pooler circuitry 120, the example column pooler circuitry 125, the example output generator circuitry 130 and/or, more generally, the pooling performer circuitry 105 of FIG. 1 could be implemented by programmable circuitry, processor circuitry, analog circuit(s), digital circuit(s), logic circuit(s), programmable processor(s), programmable microcontroller(s), graphics processing unit(s) (GPU(s)), digital signal processor(s) (DSP(s), ASIC(s)), programmable logic device(s) (PLD(s)), vision processing units (VPUs), and/or field programmable logic device(s) (FPLD(s)) such as FPGAs in combination with machine readable instructions (e.g., firmware or software). Further still, the pooling performer circuitry 105 of FIG. 1 may include one or more elements, processes, and/or devices in addition to, or instead of, those illustrated in FIG. 1, and/or may include more than one of any or all of the illustrated elements, processes and devices.

Flowcharts representative of example machine readable instructions, which may be executed by programmable circuitry to implement and/or instantiate the pooling performer circuitry 105 of FIG. 1 and/or representative of example operations which may be performed by programmable circuitry to implement and/or instantiate the pooling performer circuitry 105, are shown in FIGS. 2-3. The machine readable instructions may be one or more executable programs or portion(s) of one or more executable programs for execution by programmable circuitry, such as the programmable circuitry 912 shown in the example processor platform 900 discussed below in connection with FIG. 9 and/or may be one or more function(s) or portion(s) of functions to be performed by the example programmable circuitry (e.g., an FPGA) discussed below in connection with FIGS. 10 and/or 11. In some examples, the machine readable instructions cause an operation, a task, etc., to be carried out and/or performed in an automated manner in the real world. As used herein, “automated” means without human involvement.

The program may be embodied in instructions (e.g., software and/or firmware) stored on one or more non-transitory computer readable and/or machine readable storage medium such as cache memory, a magnetic-storage device or disk (e.g., a floppy disk, a Hard Disk Drive (HDD), etc.), an optical-storage device or disk (e.g., a Blu-ray disk, a Compact Disk (CD), a Digital Versatile Disk (DVD), etc.), a Redundant Array of Independent Disks (RAID), a register, ROM, a solid-state drive (SSD), SSD memory, non-volatile memory (e.g., electrically erasable programmable read-only memory (EEPROM), flash memory, etc.), volatile memory (e.g., Random Access Memory (RAM) of any type, etc.), and/or any other storage device or storage disk. The instructions of the non-transitory computer readable and/or machine readable medium may program and/or be executed by programmable circuitry located in one or more hardware devices, but the entire program and/or parts thereof could alternatively be executed and/or instantiated by one or more hardware devices other than the programmable circuitry and/or embodied in dedicated hardware. The machine readable instructions may be distributed across multiple hardware devices and/or executed by two or more hardware devices (e.g., a server and a client hardware device). For example, the client hardware device may be implemented by an endpoint client hardware device (e.g., a hardware device associated with a human and/or machine user) or an intermediate client hardware device gateway (e.g., a radio access network (RAN)) that may facilitate communication between a server and an endpoint client hardware device. Similarly, the non-transitory computer readable storage medium may include one or more mediums. Further, although the example program is described with reference to the flowcharts illustrated in FIGS. 2-3, many other methods of implementing the example pooling performer circuitry 105 of FIG. 1 may alternatively be used. For example, the order of execution of the blocks of the flowchart(s) may be changed, and/or some of the blocks described may be changed, eliminated, or combined. Additionally or alternatively, any or all of the blocks of the flow chart may be implemented by one or more hardware circuits (e.g., processor circuitry, discrete and/or integrated analog and/or digital circuitry, an FPGA, an ASIC, a comparator, an operational-amplifier (op-amp), a logic circuit, etc.) structured to perform the corresponding operation without executing software or firmware. The programmable circuitry may be distributed in different network locations and/or local to one or more hardware devices (e.g., a single-core processor (e.g., a single core CPU), a multi-core processor (e.g., a multi-core CPU, an XPU, etc.)). As used herein, programmable circuitry includes any type(s) of circuitry that may be programmed to perform a desired function such as, for example, a CPU, a GPU, a VPU, and/or an FPGA. The programmable circuitry may include one or more CPUs, one or more GPUs, one or more VPUs, and/or one or more FPGAs located in the same package (e.g., the same integrated circuit (IC) package or in two or more separate housings), one or more CPUs, GPUs, VPUs, and/or one or more FPGAs in a single machine, multiple CPUs, GPUs, VPUs, and/or FPGAs distributed across multiple servers of a server rack, and/or multiple CPUs, GPUS, VPUs, and/or FPGAs distributed across one or more server racks. Additionally or alternatively, programmable circuitry may include a programmable logic device (PLD), a generic array logic (GAL) device, a programmable array logic (PAL) device, a complex programmable logic device (CPLD), a simple programmable logic device (SPLD), a microcontroller (MCU), a programmable system on chip (PSoC), etc., and/or any combination(s) thereof in any of the contexts explained above.

The machine readable instructions described herein may be stored in one or more of a compressed format, an encrypted format, a fragmented format, a compiled format, an executable format, a packaged format, etc. Machine readable instructions as described herein may be stored as data (e.g., computer-readable data, machine-readable data, one or more bits (e.g., one or more computer-readable bits, one or more machine-readable bits, etc.), a bitstream (e.g., a computer-readable bitstream, a machine-readable bitstream, etc.), etc.) or a data structure (e.g., as portion(s) of instructions, code, representations of code, etc.) that may be utilized to create, manufacture, and/or produce machine executable instructions. For example, the machine readable instructions may be fragmented and stored on one or more storage devices, disks and/or computing devices (e.g., servers) located at the same or different locations of a network or collection of networks (e.g., in the cloud, in edge devices, etc.). The machine readable instructions may require one or more of installation, modification, adaptation, updating, combining, supplementing, configuring, decryption, decompression, unpacking, distribution, reassignment, compilation, etc., in order to make them directly readable, interpretable, and/or executable by a computing device and/or other machine. For example, the machine readable instructions may be stored in multiple parts, which are individually compressed, encrypted, and/or stored on separate computing devices, wherein the parts when decrypted, decompressed, and/or combined form a set of computer-executable and/or machine executable instructions that implement one or more functions and/or operations that may together form a program such as that described herein.

In another example, the machine readable instructions may be stored in a state in which they may be read by programmable circuitry, but require addition of a library (e.g., a dynamic link library (DLL)), a software development kit (SDK), an application programming interface (API), etc., in order to execute the machine-readable instructions on a particular computing device or other device. In another example, the machine readable instructions may need to be configured (e.g., settings stored, data input, network addresses recorded, etc.) before the machine readable instructions and/or the corresponding program(s) can be executed in whole or in part. Thus, machine readable, computer readable and/or machine readable media, as used herein, may include instructions and/or program(s) regardless of the particular format or state of the machine readable instructions and/or program(s).

The machine readable instructions described herein can be represented by any past, present, or future instruction language, scripting language, programming language, etc. For example, the machine readable instructions may be represented using any of the following languages: C, C++, Java, C #, Perl, Python, JavaScript, HyperText Markup Language (HTML), Structured Query Language (SQL), Swift, etc.

As mentioned above, the example operations of FIGS. 2-3 may be implemented using executable instructions (e.g., computer readable and/or machine readable instructions) stored on one or more non-transitory computer readable and/or machine readable media. As used herein, the terms non-transitory computer readable medium, non-transitory computer readable storage medium, non-transitory machine readable medium, and/or non-transitory machine readable storage medium are expressly defined to include any type of computer readable storage device and/or storage disk and to exclude propagating signals and to exclude transmission media. Examples of such non-transitory computer readable medium, non-transitory computer readable storage medium, non-transitory machine readable medium, and/or non-transitory machine readable storage medium include optical storage devices, magnetic storage devices, an HDD, a flash memory, a read-only memory (ROM), a CD, a DVD, a cache, a RAM of any type, a register, and/or any other storage device or storage disk in which information is stored for any duration (e.g., for extended time periods, permanently, for brief instances, for temporarily buffering, and/or for caching of the information). As used herein, the terms “non-transitory computer readable storage device” and “non-transitory machine readable storage device” are defined to include any physical (mechanical, magnetic and/or electrical) hardware to retain information for a time period, but to exclude propagating signals and to exclude transmission media. Examples of non-transitory computer readable storage devices and/or non-transitory machine readable storage devices include random access memory of any type, read only memory of any type, solid state memory, flash memory, optical discs, magnetic disks, disk drives, and/or redundant array of independent disks (RAID) systems. As used herein, the term “device” refers to physical structure such as mechanical and/or electrical equipment, hardware, and/or circuitry that may or may not be configured by computer readable instructions, machine readable instructions, etc., and/or manufactured to execute computer-readable instructions, machine-readable instructions, etc.

FIG. 2 is a flowchart representative of example machine readable instructions and/or example operations 200 that may be executed, instantiated, and/or performed by programmable circuitry to implement the example pooling performer circuitry 105 of FIG. 1. The machine-readable instructions and/or the operations 200 of FIG. 2 begin at block 205, at which the input identifier circuitry 110 determines whether a pooling operation is to be performed using a GPU-based architecture. In some examples, the input identifier circuitry 110 determines whether to proceed with the pooling operations disclosed herein based on whether the pooling operation is to be performed using a CPU and/or a GPU. For pooling operations performed on a GPU, the input identifier circuitry 110 receives n-dimensional input with (1) N-M batch dimensions including M working data dimensions and (2) a pooling size of M dimensions, at block 210. In examples disclosed herein, the input identifier circuitry 110 distributes the pooling operation workload (e.g., computing task) across one or more core(s) based on the input batch dimensions, at block 215. For example, the input identifier circuitry 110 allocates a set of data units (H×W) for processing to each core, as described in connection with FIG. 1. The pooling performer circuitry 105 proceeds to perform m-dimensional average pooling, at block 220. For example, as described in more detail in connection with FIG. 3, the row pooler circuitry 120 generates first intermediate output by performing row-based pooling operations and the column pooler circuitry 125 generates second intermediate output by performing column-based pooling operations. Once all pooling operations are completed, the output generator circuitry 130 outputs data with updated N-M batch dimensions and M working data dimensions, at block 225.

FIG. 3 is a flowchart representative of example machine-readable instructions and/or example operations 220 that may be executed, instantiated, and/or performed by example programmable circuitry to implement the example pooling performer circuitry 105 of FIG. 1 to perform m-dimensional average pooling. The machine-readable instructions and/or the operations 220 of FIG. 2 begin at block 305, at which the row pooler circuitry 120 identifies a number of row(s) and/or column(s) that can be accommodated in a shared local memory (SLM). In the example of FIG. 3, the row pooler circuitry 120 identifies an input of next K elements associated with a given dimension, at block 310. For example, the row pooler circuitry 120 uses a thread (e.g., an instruction executed by the core) to obtain subsequent K elements from input[i][j]. Subsequently, the row pooler circuitry 120 generates first intermediate output by performing summation of the next K elements, at block 315. For example, the row pooler circuitry 120 computes a sum of the elements as the resulting intermediate output (e.g., when the thread is for output at an index[i][j]), as described in more detail in connection with FIGS. 1 and 5A. Subsequently, the row pooler circuitry 120 moves the first intermediate output (e.g., input_v2[i][j] output(s) shown in connection with FIG. 1) to the SLM, at block 320. In some examples, the row pooler circuitry 120 stores the first intermediate output by interchanging dimensions to allow for contiguous memory access for a subsequent dimension, at block 325. Accordingly, example intermediate output input_v2[H][W] can be stored as input_v2[W][H].

Once the row-based pooling operation is complete, the column pooler circuitry 125 identifies a subsequent input of K elements, at block 330. Once the column pooler circuitry 125 retrieves the next K elements, the column pooler circuitry 125 generates a second intermediate output based on a division of the summed elements by a constant value (e.g., size of kernel), at block 335. For example, the column pooler circuitry 125 fetches the subsequent K elements associated with input[i][j] from the SLM (e.g., based on a column major order), and performs a summation operation to determine the corresponding output, dividing the sum by a constant value (K1×K2), as shown and described in connection with FIGS. 1 and 5B. Once the column pooler circuitry 125 completes the column-based pooling operation, at block 340, the column pooler circuitry 125 moves the final output(s) from the SLM to the cache, at block 345.

FIG. 4 illustrates an example representation 400 of a two-dimensional (2D) matrix (I) indicating an example input image 405 of a given size (e.g., N×M) and an example resulting output image 415 of the pooling operation (e.g., (N−K1+1)×(M−K2+1)), with a kernel of size K1×K2. For all sub-matrices S (e.g., a first sub-matrix 410) of input I of size K1×K2, F(E) can be determined based on a mathematical operation (F) and a set of all elements (E) in the sub-matrix S. The resulting output F(E) represents the output at index[i][j], where [i][j] is an index of the top-left most element of the sub-matrix S. Multiple variants can be represented based on the output F(E). For example, for an average value pooling operation (AvgPool), F( ) represents the average of all elements, while for a maximum value pooling operation (MaxPool), F( ) represents the maximum of all elements. In some examples, known pooling techniques include traversing through all sub-matrices S (e.g., of size K1×K2) in the input. For a current sub-matrix starting at index (i, j), pooling is determined using an average value for the AvgPool operation and a maximum value for the MaxPool operation. In some examples, the output element can be set at an index (i, j) of the output matrix (e.g., output image 415), with a second sub-matrix 420 indicating the output result of the pooling operation(s).

FIG. 5A illustrates an example calculation associated with select row(s) of data as part of a pooling operation 500 performed using the pooling performer circuitry 105 of FIG. 1. In the example of FIG. 5A, the row pooler circuitry 120 receives input 505 (e.g., input[H][W]) and generates first intermediate data 520 (e.g., input_v2[H][W]). In examples disclosed herein, the row pooler circuitry 120 fetches first K elements 510 (e.g., from input[i][j]) associated with a first row of the input 505 and computes a first sum of the K elements as output (e.g., first output 525). Subsequently, the row pooler circuitry 120 fetches the second K elements 515 associated with a second row of the input 505 and computes a second sum of the K elements as output (e.g., second output 530). Once the first intermediate output is ready, the row pooler circuitry 120 moves the first intermediate output to the Shared Local Memory (SLM). For example, as described in connection with FIG. 1, the row pooler circuitry 120 can identify input_v2[i][j] as a sum of (input[i][j], input[i][j+1], input[i][j+2], . . . , input[i][j+K1−1]).

FIG. 5B illustrates an example calculation associated with select column(s) of data as part of a pooling operation 550 performed using the pooling performer circuitry 105 of FIG. 1. In the example of FIG. 5B, the input received by the column pooler circuitry 125 can be represented as the first intermediate output (e.g., input_v2[H][W]), resulting in the second intermediate output (e.g., input_v3[H−K2][W−K1]). For example, given input 555, the column pooler circuitry 125 retrieves K elements (e.g., K2 elements 560) associated with input[i][j] from the SLM (e.g., using the column major order) and determines the sum as a first output (e.g., sum of K2 elements 570 in output 565), dividing the sum by a constant value (e.g., K1×K2) to obtain a second output (e.g., average 575). As described in connection with FIG. 1, an example of such an average calculation can be represented by input_v3[i][j]=sum of (input_v2[i][j], input_v2[i+1][j], input_v2[i+2][j], . . . , input_v2[i+K2−1][j])/(K1×K2). In some examples, the column pooler circuitry 125 removes additional elements during the computation, as shown in connection with output 580 (e.g., representing modified output 585 as input_v3[H−K2][W−K1]).

FIG. 6A illustrates an example reordering of dimensions 600 based on calculations associated with select row(s) of data as part of a pooling operation performed using the pooling performer circuitry 105 of FIG. 1. To achieve memory optimization and/or to maintain contiguous memory access as part of row-based pooling operations performed in connection with FIG. 5A, the row pooler circuitry 120 stores intermediate output(s) by interchanging dimensions. In the example of FIG. 6A, the row pooler circuitry 120 obtains the original intermediate output shown in connection with FIG. 5A (e.g., based on first output 525 and second output 530, when dimensions are not reordered such that input_v2[H][W]). Once the row pooler circuitry 120 reorders the dimensions, the intermediate output (e.g., output 605) can be represented as input_v2[W][H], as shown using example re-ordered dimension output(s) 610, 615 of FIG. 6A.

FIG. 6B illustrates an example pooling operation 650 performed using the pooling performer circuitry 105 of FIG. 1. During row-based and column-based pooling operations, processing of dimensions changes their order, except for the last dimension processed. The last dimension involves row-wise pooling, given that the last dimension from the left-hand side of the input represents the original last dimension from the right-hand side of the input, such that the final output can be stored in the correct order, which does not introduce any overhead in the GPU-based architecture. In the example of FIG. 6B, the current dimension represents the last dimension. For example, input 655 input_v2[W][H] (e.g., with re-ordered dimensions) includes a first set of K2 elements 660 and a second set of K2 elements 665. The resulting output 670 includes a sum of the K2 elements represented by re-ordered dimension output(s) 675, 680.

FIG. 7A illustrates example memory accesses 700 using known pooling techniques. As previously described, pooling is a memory bound operation, such that reducing the number of memory accesses for each element significantly improves performance. In the example of FIG. 7A, a matrix 702 with output 704 uses K×K input elements (e.g., input elements 708 of matrix 706). In particular, 2D pooling techniques use K×K input elements for every output element. In the example of FIG. 7A, a total of K memory accesses (e.g., memory access(es) 712, 714, 716 of matrix 710) are needed when using known 2D pooling techniques, given that there are K segments of contiguous memory.

In contrast, FIG. 7B illustrates example reduced memory accesses 750 when performing pooling operations using the pooling performer circuitry 105 of FIG. 1. In the example of FIG. 7B, the same output 702 results in a single memory access associated with row-based pooling operations performed by the row pooler circuitry 120 (e.g., memory access 754 in matrix 752) and column-based pooling operations performed by the column pooler circuitry 125 (e.g., memory access 762 in matrix 760). As such, the number of memory accesses is constant (e.g., representing the number of pooling dimensions), using a total of two memory accesses for every output element.

FIG. 8 shows example pooling operation results 800 with and without the use of Single Instruction, Multiple Data (SIMD)-based optimization performed using a GPU-based architecture (e.g., Intel® Ponte Vecchio GPU with an existing optimized pooling operation in IPEX). In the example of FIG. 8, measurements are obtained using input data sizes of 128×128 ×32×32 (using an NCHW format, where N represents a number of images, C represents a number of channels, H represents a height, and W represents a width). The pooling operation results 800 include example kernel size(s) 802, example IPEX-based results 806, disclosed method results 808 (e.g., including results without SIMD and with SIMD optimization), improvement factor results 810, and theoretical improvement factor (K/2) results 812. For examples implemented without the use of SIMD-based optimization (e.g., using small kernel sizes of up to 6), the improvement factor 810 is close to the theoretical improvement factor 812 of K/2. For larger kernel sizes, the improvement is observed to range between three to four times, given that the generated SIMD instructions are serialized due to variable loop length(s). For example, the compiler does not effectively optimize due to an unpredictability in loop iteration count and alignment for larger filter sizes.

By incorporating SIMD optimizations using methods and apparatus disclosed herein, thereby adjusting the loop structure to adjust with SIMD width, a significant performance improvement (e.g., of a factor of K/2) is observed, being in line with theoretical predictions. For all kernel sizes tested, the performance improvement (e.g., improvement factor 810) is significant. In examples disclosed herein, maximum workgroup size memory is allocated on shared memory, with no additional memory overhead. In production models, the standard kernel sizes for pooling are 3×3, 5×5, 7×7 and 11×11, including the use of 2D and 3D pooling variants. Based on the observed improvements in the pooling operations, projected performance improvements for end-to-end inference with convolutional neural network (CNN) models can be shown as follows: An overall performance improvement of 11.19% using AlexNet, 9.90% using VGG16, 13.70% using GoogleNet, and 13.48% using Inception-v3. For example, in most of the CNN models, convolution consumes up to 70% of the inference time, followed by pooling operations (e.g., which consume up to 20% of the inference time on average). Using methods and apparatus disclosed herein for pooling operations, the end-to-end inference performance improves from 9.90% to 13.70%.

FIG. 9 is a block diagram of an example programmable circuitry platform 900 structured to execute and/or instantiate the example machine-readable instructions and/or the example operations of FIGS. 2-3 to implement the example pooling performer circuitry 105 of FIG. 1. The programmable circuitry platform 900 can be, for example, a server, a personal computer, a workstation, a self-learning machine (e.g., a neural network), a mobile device (e.g., a cell phone, a smart phone, a tablet such as an iPad™), a personal digital assistant (PDA), an Internet appliance, a DVD player, a CD player, a digital video recorder, a Blu-ray player, a gaming console, a personal video recorder, a set top box, a headset (e.g., an augmented reality (AR) headset, a virtual reality (VR) headset, etc.) or other wearable device, or any other type of computing and/or electronic device.

The programmable circuitry platform 900 of the illustrated example includes programmable circuitry 912. The programmable circuitry 912 of the illustrated example is hardware. For example, the programmable circuitry 912 can be implemented by one or more integrated circuits, logic circuits, FPGAs microprocessors, CPUs, GPUs, DSPs, and/or microcontrollers from any desired family or manufacturer. The programmable circuitry 912 may be implemented by one or more semiconductor based (e.g., silicon based) devices. In this example, the processor circuitry 912 implements the input identifier circuitry 110, the row pooler circuitry 120, the column pooler circuitry 124, and the output generator circuitry 130.

The programmable circuitry 912 of the illustrated example includes a local memory 913 (e.g., a cache, registers, etc.). The programmable circuitry 912 of the illustrated example is in communication with a main memory including a volatile memory 914 and a non-volatile memory 916 by a bus 918. The volatile memory 914 may be implemented by Synchronous Dynamic Random Access Memory (SDRAM), Dynamic Random Access Memory (DRAM), RAMBUS® Dynamic Random Access Memory (RDRAM®), and/or any other type of RAM device. The non-volatile memory 916 may be implemented by flash memory and/or any other desired type of memory device. Access to the main memory 914, 916 of the illustrated example is controlled by a memory controller 917. In some examples, the memory controller 917 may be implemented by one or more integrated circuits, logic circuits, microcontrollers from any desired family or manufacturer, or any other type of circuitry to manage the flow of data going to and from the main memory 914, 916.

The programmable circuitry platform 900 of the illustrated example also includes interface circuitry 920. The interface circuitry 920 may be implemented by hardware in accordance with any type of interface standard, such as an Ethernet interface, a universal serial bus (USB) interface, a Bluetooth® interface, a near field communication (NFC) interface, a Peripheral Component Interconnect (PCI) interface, and/or a Peripheral Component Interconnect Express (PCIe) interface.

In the illustrated example, one or more input devices 922 are connected to the interface circuitry 920. The input device(s) 922 permit(s) a user (e.g., a human user, a machine user, etc.) to enter data and/or commands into the programmable circuitry 912. The input device(s) 922 can be implemented by, for example, an audio sensor, a microphone, a camera (still or video), a keyboard, a button, a mouse, a touchscreen, a track-pad, a trackball, an isopoint device, and/or a voice recognition system.

One or more output devices 924 are also connected to the interface circuitry 920 of the illustrated example. The output devices 924 can be implemented, for example, by display devices (e.g., a light emitting diode (LED), an organic light emitting diode (OLED), a liquid crystal display (LCD), a cathode ray tube (CRT) display, an in-place switching (IPS) display, a touchscreen, etc.), a tactile output device, a printer, and/or speaker. The interface circuitry 920 of the illustrated example, thus, typically includes a graphics driver card, a graphics driver chip, and/or graphics processor circuitry such as a GPU.

The interface circuitry 920 of the illustrated example also includes a communication device such as a transmitter, a receiver, a transceiver, a modem, a residential gateway, a wireless access point, and/or a network interface to facilitate exchange of data with external machines (e.g., computing devices of any kind) by a network 926. The communication can be by, for example, an Ethernet connection, a digital subscriber line (DSL) connection, a telephone line connection, a coaxial cable system, a satellite system, a line-of-site wireless system, a cellular telephone system, an optical connection, etc.

The programmable circuitry platform 900 of the illustrated example also includes one or more mass storage devices 928 to store software and/or data. Examples of such mass storage devices 928 include magnetic storage devices (e.g., floppy disk, drives, HDDs, etc.), optical storage devices (e.g., Blu-ray disks, CDs, DVDs, etc.), RAID systems, and/or solid-state storage discs or devices such as flash memory devices and/or SSDs.

The machine executable instructions 932, which may be implemented by the machine readable instructions of FIGS. 2-3, may be stored in the mass storage device 928, in the volatile memory 914, in the non-volatile memory 916, and/or on at least one non-transitory computer readable storage medium such as a CD or DVD which may be removable.

FIG. 10 is a block diagram of an example implementation of the programmable circuitry 912 of FIG. 9. In this example, the programmable circuitry 912 of FIG. 9 is implemented by a microprocessor 1000. For example, the microprocessor 1000 may be a general purpose microprocessor (e.g., general purpose microprocessor circuitry). The microprocessor 1000 executes some or all of the machine readable instructions of the flowcharts of FIGS. 2-3 to effectively instantiate the circuitry of FIG. 1 logic circuits to perform the operations corresponding to those machine readable instructions. In some such examples, the circuitry of FIG. 1 is instantiated by the hardware circuits of the microprocessor 1000 in combination with the instructions. For example, the microprocessor 1000 may implement multi-core hardware circuitry such as a CPU, a DSP, a GPU, an XPU, etc. Although it may include any number of example cores 1002 (e.g., 1 core), the microprocessor 1000 of this example is a multi-core semiconductor device including N cores. The cores 1002 of the microprocessor 1000 may operate independently or may cooperate to execute machine readable instructions. For example, machine code corresponding to a firmware program, an embedded software program, or a software program may be executed by one of the cores 1002 or may be executed by multiple ones of the cores 1002 at the same or different times. In some examples, the machine code corresponding to the firmware program, the embedded software program, or the software program is split into threads and executed in parallel by two or more of the cores 1002. The software program may correspond to a portion or all of the machine readable instructions and/or operations represented by the flowcharts of FIGS. 2-3.

The cores 1002 may communicate by a first example bus 1004. In some examples, the first bus 1004 may implement a communication bus to effectuate communication associated with one(s) of the cores 1002. For example, the first bus 1004 may implement at least one of an Inter-Integrated Circuit (I2C) bus, a Serial Peripheral Interface (SPI) bus, a PCI bus, or a PCIe bus. Additionally or alternatively, the first bus 1004 may implement any other type of computing or electrical bus. The cores 1002 may obtain data, instructions, and/or signals from one or more external devices by example interface circuitry 1006. The cores 1002 may output data, instructions, and/or signals to the one or more external devices by the interface circuitry 1006. Although the cores 1002 of this example include example local memory 1020 (e.g., Level 1 (L1) cache that may be split into an LI data cache and an L1 instruction cache), the microprocessor 1000 also includes example shared memory 1010 that may be shared by the cores (e.g., Level 2 (L2_cache)) for high-speed access to data and/or instructions. Data and/or instructions may be transferred (e.g., shared) by writing to and/or reading from the shared memory 1010. The local memory 1020 of each of the cores 1002 and the shared memory 1010 may be part of a hierarchy of storage devices including multiple levels of cache memory and the main memory (e.g., the main memory 914, 916 of FIG. 9). Typically, higher levels of memory in the hierarchy exhibit lower access time and have smaller storage capacity than lower levels of memory. Changes in the various levels of the cache hierarchy are managed (e.g., coordinated) by a cache coherency policy.

Each core 1002 may be referred to as a CPU, DSP, GPU, etc., or any other type of hardware circuitry. Each core 1002 includes control unit circuitry 1014, arithmetic and logic (AL) circuitry (sometimes referred to as an ALU) 1016, a plurality of registers 1018, the L1 cache 1020, and a second example bus 1022. Other structures may be present. For example, each core 1002 may include vector unit circuitry, single instruction multiple data (SIMD) unit circuitry, load/store unit (LSU) circuitry, branch/jump unit circuitry, floating-point unit (FPU) circuitry, etc. The control unit circuitry 1014 includes semiconductor-based circuits structured to control (e.g., coordinate) data movement within the corresponding core 1002. The AL circuitry 1016 includes semiconductor-based circuits structured to perform one or more mathematic and/or logic operations on the data within the corresponding core 1002. The AL circuitry 1016 of some examples performs integer-based operations. In other examples, the AL circuitry 1016 also performs floating-point operations. In yet other examples, the AL circuitry 1016 may include first AL circuitry that performs integer-based operations and second AL circuitry that performs floating point operations. In some examples, the AL circuitry 1016 may be referred to as an Arithmetic Logic Unit (ALU).

The registers 1018 are semiconductor-based structures to store data and/or instructions such as results of one or more of the operations performed by the AL circuitry 1016 of the corresponding core 1002. For example, the registers 1018 may include vector register(s), SIMD register(s), general purpose register(s), flag register(s), segment register(s), machine specific register(s), instruction pointer register(s), control register(s), debug register(s), memory management register(s), machine check register(s), etc. The registers 1018 may be arranged in a bank as shown in FIG. 10. Alternatively, the registers 1018 may be organized in any other arrangement, format, or structure including distributed throughout the core 1002 to shorten access time. The second bus 1022 may be implemented by at least one of an I2C bus, a SPI bus, a PCI bus, or a PCIe bus.

Each core 1002 and/or, more generally, the microprocessor 1000 may include additional and/or alternate structures to those shown and described above. For example, one or more clock circuits, one or more power supplies, one or more power gates, one or more cache home agents (CHAs), one or more converged/common mesh stops (CMSs), one or more shifters (e.g., barrel shifter(s)) and/or other circuitry may be present. The microprocessor 1000 is a semiconductor device fabricated to include many transistors interconnected to implement the structures described above in one or more integrated circuits (ICs) contained in one or more packages.

The microprocessor 1000 may include and/or cooperate with one or more accelerators (e.g., acceleration circuitry, hardware accelerators, etc.). In some examples, accelerators are implemented by logic circuitry to perform certain tasks more quickly and/or efficiently than can be done by a general-purpose processor. Examples of accelerators include ASICs and FPGAs such as those discussed herein. A GPU, DSP and/or other programmable device can also be an accelerator. Accelerators may be on-board the microprocessor 1000, in the same chip package as the microprocessor 1000 and/or in one or more separate packages from the microprocessor 1000.

FIG. 11 is a block diagram of another example implementation of the programmable circuitry of FIG. 9. In this example, the programmable circuitry 912 is implemented by FPGA circuitry 1100. For example, the FPGA circuitry 1100 may be implemented by an FPGA. The FPGA circuitry 1100 can be used, for example, to perform operations that could otherwise be performed by the example microprocessor 1000 of FIG. 10 executing corresponding machine readable instructions. However, once configured, the FPGA circuitry 1100 instantiates the operations and/or functions corresponding to the machine readable instructions in hardware and, thus, can often execute the operations/functions faster than they could be performed by a general-purpose microprocessor executing the corresponding software.

More specifically, in contrast to the microprocessor 1000 of FIG. 10 described above (which is a general purpose device that may be programmed to execute some or all of the machine readable instructions represented by the flowcharts of FIGS. 2-3 but whose interconnections and logic circuitry are fixed once fabricated), the FPGA circuitry 1100 of the example of FIG. 11 includes interconnections and logic circuitry that may be configured, structured, programmed, and/or interconnected in different ways after fabrication to instantiate, for example, some or all of the operations/functions corresponding to the machine readable instructions represented by the flowcharts of FIGS. 2-3. In particular, the FPGA 1100 may be thought of as an array of logic gates, interconnections, and switches. The switches can be programmed to change how the logic gates are interconnected by the interconnections, effectively forming one or more dedicated logic circuits (unless and until the FPGA circuitry 1100 is reprogrammed). The configured logic circuits enable the logic gates to cooperate in different ways to perform different operations on data received by input circuitry. Those operations may correspond to some or all of the instructions (e.g., the software and/or firmware) represented by the flowcharts of FIGS. 2-3. As such, the FPGA circuitry 1100 may be configured and/or structured to effectively instantiate some or all of the operations/functions corresponding to the machine readable instructions of the flowcharts of FIGS. 2-3 as dedicated logic circuits to perform the operations/functions corresponding to those software instructions in a dedicated manner analogous to an ASIC. Therefore, the FPGA circuitry 1100 may perform the operations/functions corresponding to the some or all of the machine readable instructions of FIGS. 2-3 faster than the general-purpose microprocessor can execute the same.

In the example of FIG. 11, the FPGA circuitry 1100 is configured and/or structured in response to being programmed (and/or reprogrammed one or more times) based on a binary file. In some examples, the binary file may be compiled and/or generated based on instructions in a hardware description language (HDL) such as Lucid, Very High Speed Integrated Circuits (VHSIC) Hardware Description Language (VHDL), or Verilog. For example, a user (e.g., a human user, a machine user, etc.) may write code or a program corresponding to one or more operations/functions in an HDL; the code/program may be translated into a low-level language as needed; and the code/program (e.g., the code/program in the low-level language) may be converted (e.g., by a compiler, a software application, etc.) into the binary file. In some examples, the FPGA circuitry 1100 of FIG. 11 may access and/or load the binary file to cause the FPGA circuitry 1100 of FIG. 11 to be configured and/or structured to perform the one or more operations/functions. For example, the binary file may be implemented by a bit stream (e.g., one or more computer-readable bits, one or more machine-readable bits, etc.), data (e.g., computer-readable data, machine-readable data, etc.), and/or machine-readable instructions accessible to the FPGA circuitry 1100 of FIG. 11 to cause configuration and/or structuring of the FPGA circuitry 1100 of FIG. 11, or portion(s) thereof.

In some examples, the binary file is compiled, generated, transformed, and/or otherwise output from a uniform software platform utilized to program FPGAs. For example, the uniform software platform may translate first instructions (e.g., code or a program) that correspond to one or more operations/functions in a high-level language (e.g., C, C++, Python, etc.) into second instructions that correspond to the one or more operations/functions in an HDL. In some such examples, the binary file is compiled, generated, and/or otherwise output from the uniform software platform based on the second instructions. In some examples, the FPGA circuitry 1100 of FIG. 11 may access and/or load the binary file to cause the FPGA circuitry 1100 of FIG. 11 to be configured and/or structured to perform the one or more operations/functions. For example, the binary file may be implemented by a bit stream (e.g., one or more computer-readable bits, one or more machine-readable bits, etc.), data (e.g., computer-readable data, machine-readable data, etc.), and/or machine-readable instructions accessible to the FPGA circuitry 1100 of FIG. 11 to cause configuration and/or structuring of the FPGA circuitry 1100 of FIG. 11, or portion(s) thereof.

The FPGA circuitry 1100 of FIG. 11, includes example input/output (I/O) circuitry 1102 to obtain and/or output data to/from example configuration circuitry 1104 and/or external hardware 1106. For example, the configuration circuitry 1104 may be implemented by interface circuitry that may obtain a binary file, which may be implemented by a bit stream, data, and/or machine-readable instructions, to configure the FPGA circuitry 1100, or portion(s) thereof. In some such examples, the configuration circuitry 1104 may obtain the binary file from a user, a machine (e.g., hardware circuitry (e.g., programmable or dedicated circuitry) that may implement an Artificial Intelligence/Machine Learning (AI/ML) model to generate the binary file), etc., and/or any combination(s) thereof). In some examples, the external hardware 1106 may be implemented by external hardware circuitry. For example, the external hardware 1106 may be implemented by the microprocessor 1000 of FIG. 10.

The FPGA circuitry 1100 also includes an array of example logic gate circuitry 1108, a plurality of example configurable interconnections 1110, and example storage circuitry 1112. The logic gate circuitry 1108 and the configurable interconnections 1110 are configurable to instantiate one or more operations/functions that may correspond to at least some of the machine readable instructions of FIGS. 2-3 and/or other desired operations. The logic gate circuitry 1108 shown in FIG. 11 is fabricated in blocks or groups. Each block includes semiconductor-based electrical structures that may be configured into logic circuits. In some examples, the electrical structures include logic gates (e.g., And gates, Or gates, Nor gates, etc.) that provide basic building blocks for logic circuits. Electrically controllable switches (e.g., transistors) are present within each of the logic gate circuitry 1108 to enable configuration of the electrical structures and/or the logic gates to form circuits to perform desired operations/functions. The logic gate circuitry 1108 may include other electrical structures such as look-up tables (LUTs), registers (e.g., flip-flops or latches), multiplexers, etc.

The configurable interconnections 1110 of the illustrated example are conductive pathways, traces, vias, or the like that may include electrically controllable switches (e.g., transistors) whose state can be changed by programming (e.g., using an HDL instruction language) to activate or deactivate one or more connections between one or more of the logic gate circuitry 1108 to program desired logic circuits.

The storage circuitry 1112 of the illustrated example is structured to store result(s) of the one or more of the operations performed by corresponding logic gates. The storage circuitry 1112 may be implemented by registers or the like. In the illustrated example, the storage circuitry 1112 is distributed amongst the logic gate circuitry 1108 to facilitate access and increase execution speed.

The example FPGA circuitry 1100 of FIG. 11 also includes example dedicated operations circuitry 1114. In this example, the dedicated operations circuitry 1114 includes special purpose circuitry 1116 that may be invoked to implement commonly used functions to avoid the need to program those functions in the field. Examples of such special purpose circuitry 1116 include memory (e.g., DRAM) controller circuitry, PCIe controller circuitry, clock circuitry, transceiver circuitry, memory, and multiplier-accumulator circuitry. Other types of special purpose circuitry may be present. In some examples, the FPGA circuitry 1100 may also include example general purpose programmable circuitry 1118 such as an example CPU 1120 and/or an example DSP 1122. Other general purpose programmable circuitry 1118 may additionally or alternatively be present such as a GPU, an XPU, etc., that can be programmed to perform other operations.

Although FIGS. 10 and 11 illustrate two example implementations of the programmable circuitry 912 of FIG. 9, many other approaches are contemplated. For example, FPGA circuitry may include an on-board CPU, such as one or more of the example CPU 1120 of FIG. 11. Therefore, the programmable circuitry 912 of FIG. 9 may additionally be implemented by combining at least the example microprocessor 1000 of FIG. 10 and the example FPGA circuitry 1100 of FIG. 11. In some such hybrid examples, one or more cores 1102 of FIG. 11 may execute a first portion of the machine readable instructions represented by the flowchart(s) of FIGS. 2-3 to perform first operation(s)/function(s), the FPGA circuitry 1100 of FIG. 11 may be configured and/or structured to perform second operation(s)/function(s) corresponding to a second portion of the machine readable instructions represented by the flowcharts of FIGS. 2-3, and/or an ASIC may be configured and/or structured to perform third operation(s)/function(s) corresponding to a third portion of the machine readable instructions represented by the flowcharts of FIGS. 2-3.

It should be understood that some or all of the circuitry of FIG. 1 may, thus, be instantiated at the same or different times. For example, same and/or different portion(s) of the microprocessor 1000 of FIG. 10 may be programmed to execute portion(s) of machine-readable instructions at the same and/or different times. In some examples, same and/or different portion(s) of the FPGA circuitry 1100 of FIG. 11 may be configured and/or structured to perform operations/functions corresponding to portion(s) of machine-readable instructions at the same and/or different times.

In some examples, some or all of the circuitry of FIG. 1 may be instantiated, for example, in one or more threads executing concurrently and/or in series. For example, the microprocessor 1000 of FIG. 10 may execute machine readable instructions in one or more threads executing concurrently and/or in series. In some examples, the FPGA circuitry 1100 of FIG. 11 may be configured and/or structured to carry out operations/functions concurrently and/or in series. Moreover, in some examples, some or all of the circuitry of FIG. 1 may be implemented within one or more virtual machines and/or containers executing on the microprocessor 1000 of FIG. 10.

In some examples, the programmable circuitry 912 of FIG. 9 may be in one or more packages. For example, the microprocessor 1000 of FIG. 10 and/or the FPGA circuitry 1100 of FIG. 11 may be in one or more packages. In some examples, an XPU may be implemented by the programmable circuitry 912 of FIG. 9 which may be in one or more packages. For example, the XPU may include a CPU (e.g., the microprocessor 1000 of FIG. 10, the CPU 1120 of FIG. 11, etc.) in one package, a DSP (e.g., the DSP 1122 of FIG. 11) in another package, a GPU in yet another package, and an FPGA (e.g., the FPGA circuitry 1100 of FIG. 11) in still yet another package.

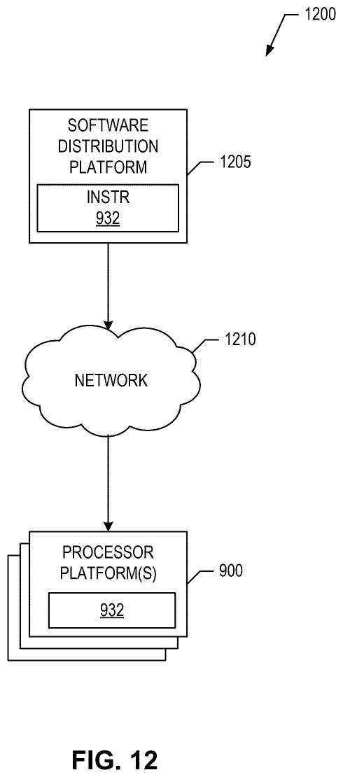

A block diagram illustrating an example software distribution platform 1205 to distribute software such as the example machine readable instructions 932 of FIG. 9 to other hardware devices (e.g., hardware devices owned and/or operated by third parties from the owner and/or operator of the software distribution platform) is illustrated in FIG. 12. The example software distribution platform 1205 may be implemented by any computer server, data facility, cloud service, etc., capable of storing and transmitting software to other computing devices. The third parties may be customers of the entity owning and/or operating the software distribution platform 1205. For example, the entity that owns and/or operates the software distribution platform 1205 may be a developer, a seller, and/or a licensor of software such as the example machine readable instructions 932 of FIG. 9. The third parties may be consumers, users, retailers, OEMs, etc., who purchase and/or license the software for use and/or re-sale and/or sub-licensing. In the illustrated example, the software distribution platform 1205 includes one or more servers and one or more storage devices. The storage devices store the machine readable instructions 932, which may correspond to the example machine readable instructions of FIGS. 2-3, as described above. The one or more servers of the example software distribution platform 1205 are in communication with an example network 1210, which may correspond to any one or more of the Internet and/or any of the example networks described above. In some examples, the one or more servers are responsive to requests to transmit the software to a requesting party as part of a commercial transaction. Payment for the delivery, sale, and/or license of the software may be handled by the one or more servers of the software distribution platform and/or by a third party payment entity. The servers enable purchasers and/or licensors to download the machine readable instructions 932 from the software distribution platform 1205. For example, the software, which may correspond to the example machine readable instructions of FIGS. 2-3, may be downloaded to the example programmable circuitry platform 900, which is to execute the machine readable instructions 932 to implement the pooling performer circuitry 105 of FIG. 1. In some examples, one or more servers of the software distribution platform 1205 periodically offer, transmit, and/or force updates to the software (e.g., the example machine readable instructions 932 of FIG. 9) to ensure improvements, patches, updates, etc., are distributed and applied to the software at the end user devices. Although referred to as software above, the distributed “software” could alternatively be firmware.

“Including” and “comprising” (and all forms and tenses thereof) are used herein to be open ended terms. Thus, whenever a claim employs any form of “include” or “comprise” (e.g., comprises, includes, comprising, including, having, etc.) as a preamble or within a claim recitation of any kind, it is to be understood that additional elements, terms, etc., may be present without falling outside the scope of the corresponding claim or recitation. As used herein, when the phrase “at least” is used as the transition term in, for example, a preamble of a claim, it is open-ended in the same manner as the term “comprising” and “including” are open ended. The term “and/or” when used, for example, in a form such as A, B, and/or C refers to any combination or subset of A, B, C such as (1) A alone, (2) B alone, (3) C alone, (4) A with B, (5) A with C, (6) B with C, or (7) A with B and with C. As used herein in the context of describing structures, components, items, objects and/or things, the phrase “at least one of A and B” is intended to refer to implementations including any of (1) at least one A, (2) at least one B, or (3) at least one A and at least one B. Similarly, as used herein in the context of describing structures, components, items, objects and/or things, the phrase “at least one of A or B” is intended to refer to implementations including any of (1) at least one A, (2) at least one B, or (3) at least one A and at least one B. As used herein in the context of describing the performance or execution of processes, instructions, actions, activities, etc., the phrase “at least one of A and B” is intended to refer to implementations including any of (1) at least one A, (2) at least one B, or (3) at least one A and at least one B. Similarly, as used herein in the context of describing the performance or execution of processes, instructions, actions, activities, etc., the phrase “at least one of A or B” is intended to refer to implementations including any of (1) at least one A, (2) at least one B, or (3) at least one A and at least one B.

As used herein, singular references (e.g., “a”, “an”, “first”, “second”, etc.) do not exclude a plurality. The term “a” or “an” object, as used herein, refers to one or more of that object. The terms “a” (or “an”), “one or more”, and “at least one” are used interchangeably herein. Furthermore, although individually listed, a plurality of means, elements, or actions may be implemented by, e.g., the same entity or object. Additionally, although individual features may be included in different examples or claims, these may possibly be combined, and the inclusion in different examples or claims does not imply that a combination of features is not feasible and/or advantageous.

As used herein, the phrase “in communication,” including variations thereof, encompasses direct communication and/or indirect communication through one or more intermediary components, and does not require direct physical (e.g., wired) communication and/or constant communication, but rather additionally includes selective communication at periodic intervals, scheduled intervals, aperiodic intervals, and/or one-time events.

As used herein, “programmable circuitry” is defined to include (i) one or more special purpose electrical circuits (e.g., an application specific circuit (ASIC)) structured to perform specific operation(s) and including one or more semiconductor-based logic devices (e.g., electrical hardware implemented by one or more transistors), and/or (ii) one or more general purpose semiconductor-based electrical circuits programmable with instructions to perform specific functions(s) and/or operation(s) and including one or more semiconductor-based logic devices (e.g., electrical hardware implemented by one or more transistors). Examples of programmable circuitry include programmable microprocessors such as Central Processor Units (CPUs) that may execute first instructions to perform one or more operations and/or functions, Field Programmable Gate Arrays (FPGAs) that may be programmed with second instructions to cause configuration and/or structuring of the FPGAs to instantiate one or more operations and/or functions corresponding to the first instructions, Graphics Processor Units (GPUs) that may execute first instructions to perform one or more operations and/or functions, Digital Signal Processors (DSPs) that may execute first instructions to perform one or more operations and/or functions, XPUs, Network Processing Units (NPUs) one or more microcontrollers that may execute first instructions to perform one or more operations and/or functions and/or integrated circuits such as Application Specific Integrated Circuits (ASICs). For example, an XPU may be implemented by a heterogeneous computing system including multiple types of programmable circuitry (e.g., one or more FPGAs, one or more CPUs, one or more GPUs, one or more NPUs, one or more DSPs, etc., and/or any combination(s) thereof), and orchestration technology (e.g., application programming interface(s) (API(s)) that may assign computing task(s) to whichever one(s) of the multiple types of programmable circuitry is/are suited and available to perform the computing task(s).

As used herein integrated circuit/circuitry is defined as one or more semiconductor packages containing one or more circuit elements such as transistors, capacitors, inductors, resistors, current paths, diodes, etc. For example, an integrated circuit may be implemented as one or more of an ASIC, an FPGA, a chip, a microchip, programmable circuitry, a semiconductor substrate coupling multiple circuit elements, a system on chip (SoC), etc.

From the foregoing, it will be appreciated that example systems, methods, apparatus, and articles of manufacture disclosed herein improve pooling operation-based computations on a GPU architecture by (1) reducing the time complexity of two-dimensional pooling by a factor of kernel size K, (2) reducing memory accesses in the GPU, and (3) reducing the number of operations and/or Single Instruction Multiple Data (SIMD) instructions by a factor of K/2 for two-dimensional pooling. For a particular element in a specific dimension, methods and apparatus disclosed herein perform pooling using subsequent K elements, updating input(s) for subsequent dimension(s). In some examples, intermediate output is stored by interchanging dimensions to ensure contiguous memory access for subsequent dimension(s). As such, methods and apparatus disclosed herein increase GPU-based performance of two-dimensional pooling operations by a factor of K/2 and reduce involved computations and/or memory accesses by a factor of K/2. Thus, examples disclosed herein result in improvements to the operation of a machine.

Example methods, apparatus, systems, and articles of manufacture for computing pooling operations on a Graphics Processing Unit (GPU) architecture are disclosed herein. Further examples and combinations thereof include the following:

Example 1 includes an apparatus, comprising interface circuitry, machine-readable instructions, and at least one processor circuit of a graphics processing unit to be programmed by the machine-readable instructions to distribute a computing task across one or more cores based on a batch dimension, execute a row pooling operation to generate a first intermediate data output based on the batch dimension and a first pooling size, execute a column pooling operation to produce a second intermediate data output based on the batch dimension and a second pooling size, and generate a final output based on the first intermediate data output and the second intermediate data output.

Example 2 includes the apparatus of example 1, wherein one or more of the at least one processor circuit is to generate the first intermediate data output by identifying a sum of the first set of elements in a row.

Example 3 includes the apparatus of one or more of examples 1-2, wherein one or more of the at least one processor circuit is to generate the second intermediate data output by identifying an average of the second set of elements in a column.

Example 4 includes the apparatus of one or more of examples 1-3, wherein one or more of the at least one processor circuit is to store the first intermediate data output by interchanging a first dimension with a second dimension for contiguous access of a shared local memory.

Example 5 includes the apparatus of one or more of examples 1-4, wherein the first dimension is a height of a two-dimensional matrix associated with the first or second intermediate data and the second dimension is a width of the two-dimensional matrix associated with the first or second intermediate data.

Example 6 includes the apparatus of one or more of examples 1-5, wherein one or more of the at least one processor circuit is to transfer the first intermediate data output or the second intermediate data output from a shared local memory to a cache.

Example 7 includes the apparatus of one or more of examples 1-6, wherein one or more of the at least one processor circuit is to apply an extension operation to the first intermediate data output or the second intermediate data output.

Example 8 includes the apparatus one or more of examples 1-7, wherein the extension operation is one of a stride or a padding.

Example 9 includes at least one non-transitory machine-readable medium comprising machine-readable instructions to cause at least one processor circuit of a graphics processing unit to at least distribute a computing task across one or more cores based on a batch dimension, execute a row pooling operation to generate a first intermediate data output based on the batch dimension and a first pooling size, execute a column pooling operation to produce a second intermediate data output based on the batch dimension and a second pooling size, and generate a final output based on the first intermediate data output and the second intermediate data output.

Example 10 includes the at least one non-transitory machine-readable medium of example 9, wherein the machine-readable instructions are to cause one or more of the at least one processor circuit to generate the first intermediate data output by identifying a sum of the first set of elements in a row.

Example 11 includes the at least one non-transitory machine-readable medium one or more of examples 9-10, wherein the machine-readable instructions are to cause one or more of the at least one processor circuit to generate the second intermediate data output by identifying an average of the second set of elements in a column.

Example 12 includes the at least one non-transitory machine-readable medium of one or more of examples 9-11, wherein the machine-readable instructions are to cause one or more of the at least one processor circuit to store the first intermediate data output by interchanging a first dimension with a second dimension for contiguous access of a shared local memory.

Example 13 includes the at least one non-transitory machine-readable medium of one or more of examples 9-12, wherein the first dimension is a height of a two-dimensional matrix associated with the first or second intermediate data and the second dimension is a width of the two-dimensional matrix associated with the first or second intermediate data.

Example 14 includes the at least one non-transitory machine-readable medium of one or more of examples 9-13, wherein the machine-readable instructions are to cause one or more of the at least one processor circuit to transfer the first intermediate data output or the second intermediate data output from a shared local memory to a cache.

Example 15 includes the at least one non-transitory machine-readable medium of one or more of examples 9-14, wherein the machine-readable instructions are to cause one or more of the at least one processor circuit to apply an extension operation to the first intermediate data output or the second intermediate data output.

Example 16 includes the at least one non-transitory machine-readable medium of one or more of examples 9-15, wherein the extension operation is one of a stride or a padding.

Example 17 includes an apparatus, comprising means for distributing a computing task across one or more cores based on a batch dimension, means for executing a row pooling operation to generate a first intermediate data output based on the batch dimension and a first pooling size, means for executing a column pooling operation to produce a second intermediate data output based on the batch dimension and a second pooling size, and means for generating a final output based on the first intermediate data output and the second intermediate data output.

Example 18 includes the apparatus of example 17, wherein the means for executing a row pooling operation is to generate the first intermediate data output by identifying a sum of the first set of elements in a row.

Example 19 includes the apparatus of one or more of examples 17-18, wherein the means for executing a column pooling operation is to generate the second intermediate data output by identifying an average of the second set of elements in a column.

Example 20 includes the apparatus of one or more of examples 17-19, wherein the means for executing a row pooling operation is to store the first intermediate data output by interchanging a first dimension with a second dimension for contiguous access of a shared local memory.

Example 21 includes the apparatus of one or more of examples 17-20, wherein the first dimension is a height of a two-dimensional matrix associated with the first or second intermediate data and the second dimension is a width of the two-dimensional matrix associated with the first or second intermediate data.

Example 22 includes the apparatus of one or more of examples 17-21, wherein the means for generating a final output is to transfer the first intermediate data output or the second intermediate data output from a shared local memory to a cache.

Example 23 includes the apparatus of one or more of examples 17-22, wherein the means for generating a final output is to apply an extension operation to the first intermediate data output or the second intermediate data output.

Example 24 includes the apparatus of one or more of examples 17-23, wherein the extension operation is one of a stride or a padding.

The following claims are hereby incorporated into this Detailed Description by this reference. Although certain example systems, methods, apparatus, and articles of manufacture have been disclosed herein, the scope of coverage of this patent is not limited thereto. On the contrary, this patent covers all systems, methods, apparatus, and articles of manufacture fairly falling within the scope of the claims of this patent.

What is claimed is:

1. An apparatus, comprising:
interface circuitry;
machine-readable instructions; and
at least one processor circuit of a graphics processing unit to be programmed by the machine-readable instructions to:
distribute a computing task across one or more cores based on a batch dimension;
execute a row pooling operation to generate a first intermediate data output based on the batch dimension and a first pooling size;
execute a column pooling operation to produce a second intermediate data output based on the batch dimension and a second pooling size; and
generate a final output based on the first intermediate data output and the second intermediate data output.

2. The apparatus of claim 1, wherein one or more of the at least one processor circuit is to generate the first intermediate data output by identifying a sum of the first set of elements in a row.

3. The apparatus of claim 1, wherein one or more of the at least one processor circuit is to generate the second intermediate data output by identifying an average of the second set of elements in a column.

4. The apparatus of claim 1, wherein one or more of the at least one processor circuit is to store the first intermediate data output by interchanging a first dimension with a second dimension for contiguous access of a shared local memory.

5. The apparatus of claim 4, wherein the first dimension is a height of a two-dimensional matrix associated with the first or second intermediate data and the second dimension is a width of the two-dimensional matrix associated with the first or second intermediate data.

6. The apparatus of claim 1, wherein one or more of the at least one processor circuit is to transfer the first intermediate data output or the second intermediate data output from a shared local memory to a cache.

7. The apparatus of claim 1, wherein one or more of the at least one processor circuit is to apply an extension operation to the first intermediate data output or the second intermediate data output.

8. The apparatus of claim 7, wherein the extension operation is at least one of a stride or a padding.

9. At least one non-transitory machine-readable medium comprising machine-readable instructions to cause at least one processor circuit of a graphics processing unit to at least:
distribute a computing task across one or more cores based on a batch dimension;
execute a row pooling operation to generate a first intermediate data output based on the batch dimension and a first pooling size;
execute a column pooling operation to produce a second intermediate data output based on the batch dimension and a second pooling size; and
generate a final output based on the first intermediate data output and the second intermediate data output.

10. The at least one non-transitory machine-readable medium of claim 9, wherein the machine-readable instructions are to cause one or more of the at least one processor circuit to generate the first intermediate data output by identifying a sum of the first set of elements in a row.

11. The at least one non-transitory machine-readable medium of claim 9, wherein the machine-readable instructions are to cause one or more of the at least one processor circuit to generate the second intermediate data output by identifying an average of the second set of elements in a column.

12. The at least one non-transitory machine-readable medium of claim 9, wherein the machine-readable instructions are to cause one or more of the at least one processor circuit to store the first intermediate data output by interchanging a first dimension with a second dimension for contiguous access of a shared local memory.

13. The at least one non-transitory machine-readable medium of claim 12, wherein the first dimension is a height of a two-dimensional matrix associated with the first or second intermediate data and the second dimension is a width of the two-dimensional matrix associated with the first or second intermediate data.

14. The at least one non-transitory machine-readable medium of claim 9, wherein the machine-readable instructions are to cause one or more of the at least one processor circuit to transfer the first intermediate data output or the second intermediate data output from a shared local memory to a cache.

15. The at least one non-transitory machine-readable medium of claim 9, wherein the machine-readable instructions are to cause one or more of the at least one processor circuit to apply an extension operation to the first intermediate data output or the second intermediate data output.

16. The at least one non-transitory machine-readable medium of claim 15, wherein the extension operation is at least one of a stride or a padding.

17. An apparatus, comprising:
means for distributing a computing task across one or more cores based on a batch dimension;
means for executing a row pooling operation to generate a first intermediate data output based on the batch dimension and a first pooling size;
means for executing a column pooling operation to produce a second intermediate data output based on the batch dimension and a second pooling size; and
means for generating a final output based on the first intermediate data output and the second intermediate data output.

18. The apparatus of claim 17, wherein the means for executing a row pooling operation is to generate the first intermediate data output by identifying a sum of the first set of elements in a row.

19. The apparatus of claim 17, wherein the means for executing a column pooling operation is to generate the second intermediate data output by identifying an average of the second set of elements in a column.

20. The apparatus of claim 17, wherein the means for executing a row pooling operation is to store the first intermediate data output by interchanging a first dimension with a second dimension for contiguous access of a shared local memory.
